(19) United States
(12) Patent Application Publication
(10) Pub. No.: US 2026/0371457 A1
(43) Pub. Date: Nov. 19, 2026

(54) LIGHTING CONTROL

(71) Applicant: Wangs Alliance Corporation, Port Washington, NY (US)

(72) Inventors: Voravit Puvanakijjakorn, Port Washington, NY (US); Wei Gao, Guangzhou City (CN); Wanqiao Xianyu, Yidu City (CN)

(21) Appl. No.: 19/442,668

(22) Filed: Jan. 7, 2026

Related U.S. Application Data
(60) Provisional application No. 63/804,864, filed on May 13, 2025.

(51) Int. Cl. H05B 45/20; H05B 45/10; H05B 45/31; H05B 45/325; H05B 45/38; H05B 45/42; H05B 47/155

(52) U.S. Cl. CPC H05B 45/20; H05B 45/10; H05B 45/31; H05B 45/325; H05B 45/38; H05B 45/42; H05B 47/155

(57) ABSTRACT

Apparatus, methods and systems for lighting control. The apparatus may provide light having a color correlated temperature (“CCT”) selectable from a range of CCTs. The apparatus may include power circuitry configured to provide power to a plurality of LEDs including a first array of LEDs having a first polarity and the highest CCT coupled in parallel with a second array of LEDs having a second polarity and the lowest CCT. The apparatus may include control circuitry that is configured to receive an input dimming level, provide a shifted dimming level based on the input dimming level and detect a voltage condition corresponding to the shifted dimming level and a current condition corresponding to the plurality of LEDs. The apparatus may include a switch that is configured to transmit a power control signal that is configured to modulate the power based on the voltage condition and the current condition.

### CROSS-REFERENCE TO RELATED APPLICATIONS

This application is a nonprovisional of U.S. Provisional Application No. 63/804,864, filed May 13, 2025 which is hereby incorporated by reference herein in its entirety.

### BACKGROUND

The brightness of light-emitting diode (“LED”) light sources is often controlled using circuits that include MOSFETs to reduce or eliminate current that flows through the light source. MOSFETs are typically opened and closed by applying a PWM signal that includes a square wave. Edge distortion in the square wave can result in conduction through the MOSFET even when the PWM duty cycle is set low, or as low as it can be set by an end user. This means that at low-brightness dimming levels, MOSFETS may remain in a partially conducting state and the corresponding light sources may not conform to the applied dimming level.

When applying a dimming level to two or more light sources that have different correlated color temperatures (“CCTs”) and are being provided current in fixed proportions to achieve a desired mixed CCT illumination effect, the edge distortion may cause the proportions to vary and thus may cause the emitted CCT to diverge from the desired CCT mix.

It would be desirable, therefore, to provide apparatus and methods for providing light having a color correlated temperature (“CCT”) that can be dimmed with reduced or eliminated divergence from a desired CCT mix.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows illustrative apparatus in accordance with the principles of the invention.

FIG. 2 shows illustrative apparatus in accordance with the principles of the invention.

FIG. 3 shows schematically illustrative apparatus in accordance with the principles of the invention.

FIG. 4 shows illustrative apparatus in accordance with the principles of the invention.

FIG. 5 shows schematically illustrative apparatus in accordance with the principles of the invention.

FIG. 6 shows illustrative apparatus in accordance with the principles of the invention.

FIG. 7 shows schematically illustrative apparatus in accordance with the principles of the invention.

FIG. 8 shows schematically illustrative apparatus in accordance with the principles of the invention.

FIG. 9 shows schematically illustrative apparatus in accordance with the principles of the invention.

FIG. 10 shows schematically illustrative apparatus in accordance with the principles of the invention.

FIG. 11 shows schematically illustrative apparatus in accordance with the principles of the invention.

FIG. 12 shows schematically illustrative apparatus in accordance with the principles of the invention.

FIG. 13 shows schematically illustrative apparatus in accordance with the principles of the invention.

FIG. 14 shows illustrative apparatus in accordance with the principles of the invention.

FIG. 15 shows illustrative apparatus in accordance with the principles of the invention.

FIG. 16 shows illustrative apparatus in accordance with the principles of the invention.

FIG. 17 shows schematically illustrative apparatus in accordance with the principles of the invention.

FIG. 18 shows schematically illustrative apparatus in accordance with the principles of the invention.

FIG. 19 shows schematically illustrative apparatus in accordance with the principles of the invention.

FIG. 20 shows schematically illustrative apparatus in accordance with the principles of the invention.

FIG. 21 shows illustrative apparatus in accordance with the principles of the invention.

FIG. 22 shows illustrative apparatus in accordance with the principles of the invention.

FIG. 23 shows schematically illustrative apparatus in accordance with the principles of the invention.

FIG. 24 shows schematically illustrative apparatus in accordance with the principles of the invention.

FIG. 25 shows schematically illustrative apparatus in accordance with the principles of the invention.

FIG. 26 shows schematically illustrative apparatus in accordance with the principles of the invention.

FIG. 27 shows schematically illustrative apparatus in accordance with the principles of the invention.

FIG. 28 shows schematically illustrative apparatus in accordance with the principles of the invention.

FIG. 29 shows schematically illustrative apparatus in accordance with the principles of the invention.

FIG. 30 shows schematically illustrative apparatus in accordance with the principles of the invention.

FIG. 31 shows schematically illustrative apparatus in accordance with the principles of the invention.

FIG. 32 shows schematically illustrative apparatus in accordance with the principles of the invention.

FIG. 33 shows schematically illustrative apparatus in accordance with the principles of the invention.

FIG. 34 shows schematically illustrative apparatus in accordance with the principles of the invention.

FIG. 35 shows schematically illustrative apparatus in accordance with the principles of the invention.

FIG. 36 shows schematically illustrative apparatus in accordance with the principles of the invention.

FIG. 37 shows schematically illustrative apparatus in accordance with the principles of the invention.

FIG. 38 shows schematically illustrative apparatus in accordance with the principles of the invention.

The leftmost digit (e.g., “L”) of a three-digit reference numeral (e.g., “LRR”), and the two leftmost digits (e.g., “LL”) of a four-digit reference numeral (e.g., “LLRR”), generally identify the first figure in which a part is called-out.

### DETAILED DESCRIPTION

Apparatus and methods for lighting are provided.

The apparatus may include one or more sections. Each section may include one or more of a light-emitting diode (“LED”), a printed circuit board (“PCB”), a circuit for providing current to the one or more LEDs, a structure for connection to another section, conductors for electrical continuity with another section, optically diffusive material, ornamental material and any other suitable features.

The apparatus may include a first section. The apparatus may include a second section. The first section may be connectable to the second section. The first section may be joined to the second section. The first section may be joined/connected to the second section via a connector and/or any other suitable connection. The first section and the second section may be monolithic. The first section may be separable from the second section. The first section may be separable from the second section via cutting the first section from the second section. The first section may be separable from the second section via any other suitable separation.

The first section may include a first PCB. The first PCB may include a first LED. The first LED may have a first color correlated temperature (“CCT”). The first LED may be included in a first string of LEDs having the first CCT. The first string of LEDs may include a one or more LEDs. The one or more LEDs may be connected in parallel, in series, or in any combination of serial and parallel connections. The one or more LEDs may be LEDs that are not connected to each other.

The first PCB may include a second LED. The second LED may have a second CCT. The first CCT may be different from the second CCT. The second LED may be included in a second string of LEDs. The second string of LEDs may have the second CCT. The second string of LEDs may include a one or more LEDs. The one or more LEDs may be connected in parallel, in a series, or in any combination of serial and parallel connections.

The first string of LEDs may be connected, in parallel, to the second string of LEDs. LEDs from the first string of LEDs may be connected, in series, to LEDs from the second string of LEDs. LEDs from the first string of LEDs may not be connected to LEDs from the second string of LEDs.

Table 1 lists illustrative ranges that may include nominal CCT values for the first CCT or the second CCT.

TABLE 1
Illustrative ranges that may include nominal
CCT values for the first and second CCTs.
Illustrative range endpoints (°K)

| Lower | Upper | Lower | Upper |
|---|---|---|---|
| <1800 | 1800 | 3400 | 3500 |
| 1800 | 1900 | 3500 | 3600 |
| 1900 | 2000 | 3600 | 3700 |
| 2000 | 2100 | 3700 | 3800 |
| 2100 | 2200 | 3800 | 3900 |
| 2200 | 2300 | 3900 | 4000 |
| 2300 | 2400 | 4000 | 4100 |
| 2400 | 2500 | 4100 | 4200 |
| 2500 | 2600 | 4200 | 4300 |
| 2600 | 2700 | 4300 | 4400 |
| 2700 | 2800 | 4400 | 4500 |
| 2800 | 2900 | 4500 | 4600 |
| 2900 | 3000 | 4600 | 4700 |
| 3000 | 3100 | 4700 | 4800 |
| 3100 | 3200 | 4800 | 4900 |
| 3200 | 3300 | 4900 | 5000 |
| 3300 | 3400 | 5000 | >5000 |
| Other | Other | Other | Other |
| suitable | suitable | suitable | suitable |
| lower | upper | lower | upper |
| endpoints | endpoints | endpoints | endpoints |

The first and second LED strings may be included in an LED module. The LED module may include a first output pole and a second output pole. The LED module may receive voltage via two conductors. The LED module may receive voltage via three conductors. The LED module may receive voltage via four conductors. The LED module may receive voltage via five conductors. The LED module may receive voltage via six conductors. The LED module may receive voltage from any suitable number of conductors. The conductors may include wires. The conductors may include any suitable conductors. The conductors may include copper. The conductors may include aluminum. The conductors may include any suitable conducting material. The conductors may be soldered to the first and second output poles. The conductors may be connected to the first and second output poles via any suitable connection. The conductors may apply voltage to the first output pole and the second output pole.

The LED module may be in electronic communication with a selector. The LED module may be in electronic communication with the selector via the conductors. The selector may be used to select a mixed CCT from a plurality of CCT states. The plurality of CCT states may include any suitable combination of the first CCT and the second CCT. The plurality of CCT states may include a plurality of preset or user selectable CCTs. The combination may include 100% of the first CCT and 0% of the second CCT. The combination may include 0% of the first CCT and 100% of the second CCT. The combination may include any suitable percentage of the first CCT and any suitable percentage of the second CCT.

The selector may be a manual selector. The selector may include a switch. The selector may include a dial. The selector may include a slider. The selector may include a button. The selector may include an electronic selector. The selector may include digital user interface. The digital user interface may be wireless. The selector may include a touchpad. The selector may include a wireless sensor. The selector may include a remote-controlled sensor. The selector may include a wired selector. The selector may include any other suitable selector.

The selector may be used to select between three CCT states. The selector may be used to select between five CCT states. The selector may be used to select between any suitable number of CCT states. The selector may be used to select from a continuous range of mixed CCTs between the first CCT and the second CCT. The selector may be used to select from a continuous range of mixed CCTs between the first CCT and the second CCT including the first CCT and the second CCT.

The LED module may be in electronic communication with a controller circuit. The controller circuit may include a microcontroller. The controller circuit may include any other suitable controller. The controller circuit may be in electronic communication with the selector. The first LED module may be in electronic communication with the controller circuit via the conductors.

In response to receiving a mixed CCT from the selector, the controller circuit may apply a voltage, having a first polarity, to the first output pole and the second output pole for a first fraction of time. In response to receiving the mixed CCT, the controller circuit may apply a voltage, having a second polarity, to the first output pole and the second output pole for a second fraction of time. The second polarity may be opposite the first polarity. The first polarity may be positive, while the second polarity may be negative. The first polarity may be negative while the second polarity may be positive. The first fraction of time may correspond to the mixed CCT. The second fraction of time may correspond to the mixed CCT. The first fraction of time and the second fraction of time may correspond to the mixed CCT.

When the selector is in a first position, the controller may control the first output pole to be a positive output pole and the second output pole to be a negative output pole. When the first output pole is a positive output pole and the second output pole is a negative output pole, LEDs having the first CCT may be ON and LEDs having the second CCT may be OFF. At this time, the CCT of the light emitted may be the first CCT.

When the selector is in a second position, the controller may control the first output pole to be a negative output pole and the second output pole to be a positive output pole. When the first output pole is a negative output pole and the second output pole is a positive output pole, LEDs having the first CCT may be OFF and LEDs having the second CCT may be ON. At this time, the CCT of the light emitted may be the second CCT.

When the user-operable CCT selector is in a third position the controller may control the first output pole for a first fraction of the time to be a positive output pole and for a second fraction of time to be a negative output pole. The second output pole may have a polarity opposite that of the first output pole. When the positive and negative frequency is large enough, the CCT of the light emitted by the LEDs having the first CCT and the LEDs having the second CCT may include a mixture of the first and second CCT. The mixed CCT may be a CCT value included in the range listed in Table 1.

The first position may correspond to the first CCT. The second position may correspond to the second CCT. The third position may correspond to any suitable mixing of the first and second CCT. The third position may include any suitable number of positions. Each of the positions may correspond to a different mixed CCT. The positions may be programmable by a user. The positions may be selectable by a user. The positions may be continuous. The positions may be analog positions. The positions may be digital positions.

A switching cycle, during which the first CCT LEDs are illuminated for the first fraction of time and the second CCT LEDs are illuminated for the second fraction of time may have any suitable duration.

The first and second fractions may be the same. The first and second fractions may be different. A sum of the first fraction and the second fraction may be about 1. The first fraction and the second fraction may be sized to result in a desired CCT mix between the first CCT and the second CCT. Table 2 lists illustrative ranges that may include the first and second fractions.

TABLE 2
Ranges that may include the first and second fractions.
Illustrative range endpoints

| Lower | Upper | Lower | Upper |
|---|---|---|---|
| <0.05 | 0.05 | 0.50 | 0.55 |
| 0.05 | 0.10 | 0.55 | 0.60 |
| 0.10 | 0.15 | 0.60 | 0.65 |
| 0.15 | 0.20 | 0.65 | 0.70 |
| 0.20 | 0.25 | 0.70 | 0.75 |
| 0.25 | 0.30 | 0.75 | 0.80 |
| 0.30 | 0.35 | 0.80 | 0.85 |
| 0.35 | 0.40 | 0.85 | 0.90 |
| 0.40 | 0.45 | 0.90 | 0.95 |
| 0.45 | 0.50 | 0.95 | >0.95 |
| Other | Other | Other | Other |
| suitable | suitable | suitable | suitable |
| lower | upper | lower | upper |
| endpoints | endpoints | endpoints | endpoints |

Apparatus and methods for providing lighting control are provided. The apparatus may provide two-wire CCT control. The apparatus may provide two-wire dimming control. The apparatus may provide simultaneous two-wire CCT and dimming control. The apparatus may provide two-wire CCT and dimming control for lighting applications. The two wires may include (1) a lighting power or current lead and (2) a MOSFET-control signal lead for a first-CCT LED, and may omit a second MOSFET-control signal lead that would be used to provide independent control of a second-CCT LED. The lighting applications may include light fixtures, light tapes, light sheets and/or any other suitable lighting applications.

The apparatus may provide light. The light may have a color correlated temperature (“CCT”). The CCT may be selectable from a range of CCTs. The range of CCTs may include a highest CCT. The range of CCTs may include a lowest CCT. The range of CCTs may include a plurality of CCTs between the highest CCT and the lowest CCT. The highest CCT and the lowest CCT may be any suitable CCT as listed in Table 1. For example, the highest CCT may be 5000 K and the lowest CCT may be 2700 K. Alternatively, the highest CCT may be 4000 K and the lowest CCT may be 1800 K. The highest CCT may be any suitable CCT including any disclosed in Table 1. The lowest CCT may be any suitable CCT including any disclosed in Table 1.

The apparatus may include power circuitry. The power circuitry may provide power to a plurality of LEDs. The plurality of LEDs may include a first array of LEDs. The first array of LEDs may have a first polarity. The first array of LEDs may have the highest CCT. The first array of LEDs may be coupled to a second array of LEDs. The first array of LEDs may be coupled in parallel with the second array of LEDs. The second array of LEDs may have a second polarity. The second array of LEDs may have the lowest CCT. The first polarity may be different than the second polarity. The first polarity may be opposite, relative to a polarity of the power circuitry, the second polarity.

The first array of LEDs may be positioned antiparallel to the second array of LEDs. The first array of LEDs may be positioned in any suitable opposing position relative to a position of the second array of LEDs.

The apparatus may include control circuitry. The control circuitry may provide a variable driving voltage to the plurality of LEDs. Relative to the variable driving voltage, the first polarity may be opposite the second polarity. The variable driving voltage may be included in a range. The range may be from about 17 VDC to about 24 VDC. The range may include a low-end that is below 17 VDC. The range may include a high end that is above 24 VDC. The variable driving voltage may be influenced by the power.

The control circuitry may receive an input dimming level. The input dimming level may correspond to a dimming selection. The dimming selection may be selected by a user. The dimming selection may be a preset dimming selection. The dimming selection may be a factory set dimming selection. The dimming selection may be an electronic dimming selection. The dimming selection may be a digital dimming selection. The dimming selection may be an analog dimming selection.

The dimming selection may be a 0-10V dimming selection. The 0-10V dimming selection may be received from a 0-10V dimming controller. The dimming selection may be an electronic low voltage (“ELV”) dimming selection. The ELV dimming selection may be received from an ELV dimming controller. The dimming selection may be a triode for alternating current (“TRIAC”) dimming selection. The TRIAC dimming selection may be received from a TRIAC dimming controller. The dimming selection may be a digital multiplex (“DMX”) dimming selection. The DMX dimming selection may be received from a DMX dimming controller. The dimming selection may be any suitable dimming selection. The dimming selection may be received from any suitable dimming controller.

The control circuitry may provide a shifted dimming level. The shifted dimming level may be based on the input dimming level. The control circuitry may include a resistance. The resistance may provide the shifted dimming level. The resistance may provide the shifted dimming level based on the input dimming level. A shifted dimming level may provide a lower light output than would the nominally corresponding input dimming level.

The resistance may be provided by a resistor. The resistance may be provided by a plurality of resistors. The resistance may be provided by a potentiometer. The resistance may be provided by a plurality of potentiometers. The resistance may be provided by any suitable component having resistant properties. The resistance may be a static resistance. The resistance may be a variable resistance. The resistance may be a tunable resistance. The resistance may be a selectable resistance.

The control circuitry may detect a voltage condition. The voltage condition may correspond to the shifted dimming level. The control circuitry may detect a current condition. The current condition may correspond to the plurality of LEDs.

The control circuitry may include a switch. The switch may include a transmitter. The switch may include at least part of an optocoupler. The switch may include an of the optocoupler. The input side may include an LED that is not in the first array of LEDs or the second array of LEDs. The switch may transmit a power control signal. The power control signal may modulate the power based on the voltage condition. The power control signal may modulate the power based on the current condition. The power control signal may modulate using ON-OFF control. The power control signal may modulate using variable control. The power control signal may modulate using only ON-OFF control. The power control signal may include a voltage. The voltage may correspond to the voltage condition. The voltage may correspond to the current condition.

The power control signal may be transmitted via the LED. The power control signal may be transmitted via light emitted from the LED. The power control signal may be transmitted to a photodetector. The photodetector may be located in the power circuitry.

The voltage condition may be defined by a comparison between the shifted dimming voltage and a threshold voltage. The threshold voltage may be a variable threshold voltage. The threshold voltage may be any suitable voltage. The control circuitry may include an operational-amplifier (“op-amp”). The op-amp may be a dual op-amp. The dual op-amp may be a first op-amp. The first op-amp may be used to compare the shifted dimming voltage to the threshold voltage.

When detecting the voltage condition, the switch may transmit the power control signal in response to the shifted dimming voltage being less than the threshold voltage.

The power circuitry may include a receiver. The receiver may include the photodetector. The photodetector may be an output side of the optocoupler. The photodetector may detect the light emitted by the LED. The photodetector may be electrically isolated from the LED. The photodetector may convert the received light back into the power control signal. The photodetector may convert the received light back into the voltage included in the power control signal. The photodetector may retrieve the voltage from the received power control signal.

The photodetector may transmit the voltage to an integrated circuit (“IC”) included in the power circuitry. The IC may compare the voltage to a reference voltage. The reference voltage may be a predetermined voltage stored in the IC. In response to the voltage being less than the reference voltage, the power circuitry may switch to an idle state. When the power circuitry is in an idle state, the power circuitry may stop providing the power to the plurality of LEDs. The power control signal may prevent the power circuitry from providing the power to the LEDs. The power control signal may prevent the power circuitry from providing the power to the LEDs by causing the power circuitry to switch to an idle state.

When the power circuitry stops providing the power to the plurality of LEDs, the variable driving voltage may be reduced. The control circuitry may include a voltage source. The voltage source may be a capacitor. The voltage source may be an electrolytic capacitor (“e-cap”). The voltage source may be any suitable voltage source. The voltage source may counteract a reduction of the variable driving voltage in response to the reduction of the power. The voltage source may counteract the reduction by releasing stored charge. Energy associated with the stored charge may maintain the variable driving voltage. Energy associated with the stored charge may maintain the variable driving voltage from reducing below a minimum voltage level. The minimum voltage level may be about 16 VDC. The minimum voltage level may be about 17 VDC. The minimum voltage level may be any suitable voltage.

The threshold voltage may be a first threshold voltage. The current condition may be defined by a comparison between a proxy voltage and a second threshold voltage. The proxy voltage may correspond to the power. The proxy voltage may correspond to a current driving the plurality of LEDs. The current driving the plurality of LEDs may correspond to the variable driving voltage. The current may be a subject of the current condition. The second threshold voltage may be about 2.5 VDC. The second threshold voltage may be any suitable voltage.

The control circuitry may include a second op-amp. The second op-amp may be used to compare the proxy voltage to the second threshold voltage.

The power control signal may be a first power control signal. The transmitter may transmit a second power control signal when the proxy voltage is greater than the threshold voltage. The voltage included in the power control signal may be a first voltage. The second power control signal may include a second voltage. The second voltage may be the same as the first voltage. The second voltage may be different from the first voltage.

The receiver may receive the second power signal. The receiver may retrieve the second voltage. The IC may compare the second voltage to the reference voltage. In response to the second voltage being less than the reference voltage, the power circuitry may switch to an idle state. When the power circuitry is in an idle state, the power circuitry may stop providing the power to the plurality of LEDs. The second power control signal may prevent the power circuitry from providing the power to the plurality of LEDs. The second power control signal may prevent the power circuitry from providing the power to the plurality of LEDs by causing the power circuitry to switch to an idle state.

The apparatus may include a microcontroller. The microcontroller may receive a CCT selection. The CCT selection may be selected by a user. The CCT selection may be selected via a controller, switch, user interface, software application and/or any other suitable selector. The microcontroller may receive the dimming selection.

The apparatus may include driver circuitry. The driver circuitry may control current that is provided to the plurality of LEDs. The current provided to the plurality of LEDs may be the driving current.

The driver circuitry may include first current-regulating gates. The first current-regulating gates may include two gates. The first current-regulating gates may include any suitable number of gates. The first current-regulating gates may include metal oxide semiconductor field effect transistors (“MOSFETs”). The first current-regulating gates may provide a first current to the plurality of LEDs. The first current-regulating gates may provide the first current for a first fraction of time. The first current may illuminate the first array of LEDs. The first current may illuminate only the first array of LEDs.

The driver circuitry may include second current-regulating gates. The second current-regulating gates may include two gates. The second current-regulating gates may include any suitable number of gates. The second current-regulating gates may include MOSFETs. The second current-regulating gates may provide a second current to the plurality of LEDs. The second current-regulating gates may provide the second current for a second fraction of time. The second current may illuminate the second array of LEDs. The second current may illuminate only the second array of LEDs.

The first current may be derived from the power. The second current may be derived from the power. The first current may have the first polarity. The second current may have the second polarity. The first current may therefore illuminate only the first array of LEDs and not the second array of LEDs. The second current may therefore illuminate only the second array of LEDs and not the first array of LEDs.

The first fraction of time and the second fraction of time may be any suitable fractions, as disclosed in Table 2. The first fraction of time and the second fraction of time may be transmitted to the driver circuitry via pulse width modulation (“PWM”) signals. The PWM signals may be transmitted from the microcontroller.

The first fraction of time may be transmitted via a first PWM signal. The second fraction of time may be transmitted via a second PWM signal. The first and second PWM signals may together define a period. The period may include a first fraction of the period and a second fraction of the period. The first fraction of the period may correspond to the first fraction of the time. The second fraction of the period may correspond to the second fraction of the time.

The first fraction of the period and the second fraction of the period may be determined based on the CCT selection received by the microcontroller. Different fractions of the period may cause the plurality of LEDs to emit light having different CCTs.

The input dimming level may be included in a dimming range. The dimming range may span from a low-end to a high-end. When the dimming level is included in the low-end of the dimming range and the CCT selection corresponds to the highest CCT, the microcontroller may output a first gate-closing signal to the driver circuitry. The first gate-closing signal may prevent power from being provided to the second array of LEDs. When the dimming level is included in the low-end of the dimming range and the CCT selection corresponds to the lowest CCT, the microcontroller may output a second gate-closing signal to the driver circuitry. The second gate-closing signal may prevent power from being provided to the second array of LEDs.

The first gate-closing signal may prevent spurious current from illuminating the second set of LEDs. The first gate-closing signal may enable only the first array of LEDs to be illuminated. The second gate-closing signal may prevent leakage current from illuminating the first set of LEDs. The second gate-closing signal may enable only the second array of LEDs to be illuminated.

The first gate-closing signal and the second gate-closing signal may be PWM signals. The first gate-closing signal and the second gate-closing signal may be transmitted from the microcontroller to the driver circuitry.

The driver circuitry may include a first auxiliary current-regulating gate. In response to receiving the first gate-closing signal, the first auxiliary current-regulating gate may prevent the second current-regulating gates from providing the second current to the second array of LEDs. The driver circuitry may include a second auxiliary current-regulating gate. In response to receiving the second gate-closing signal, the second auxiliary current-regulating gate may prevent the first current-regulating gates from providing the first current to the first array of LEDs.

The first auxiliary current-regulating gate may include a MOSFET. The first auxiliary current-regulating gate may include any other suitable current-regulating circuitry. The second auxiliary current-regulating gate may include a MOSFET. The second auxiliary current-regulating gate may include any other suitable current-regulating circuitry.

Illustrative embodiments of apparatus and methods in accordance with the principles of the invention will now be described with reference to the accompanying drawings, which form a part hereof. It is to be understood that other embodiments may be utilized, and that structural, functional and procedural modifications or omissions may be made without departing from the scope and spirit of the present invention.

Some embodiments may omit features shown and/or described in connection with the illustrative apparatus. Some embodiments may include features that are neither shown nor described in connection with the illustrative apparatus. Features of illustrative apparatus may be combined. For example, one illustrative embodiment may include features shown in connection with another illustrative embodiment.

Embodiments may involve some or all of the features of the illustrative apparatus and/or some or all of the steps of the methods associated therewith.

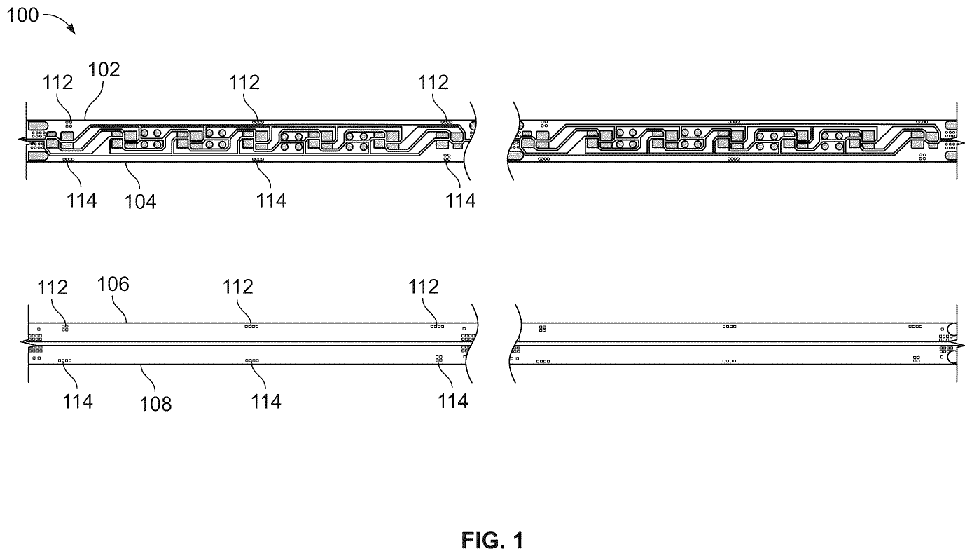

FIG. 1 shows an illustrative schematic in accordance with the principles of this invention. FIG. 1 shows illustrative light tape 100. Light tape 100 may include a first base. The first base may include first base layer 102. The first base may include first base layer 106. First base layer 102 and first base layer 106 may include a conductive material. The conductive material may include copper, aluminum or any other suitable conductive material. Light tape 100 may include a second base. The second base may include second base layer 104. The second base may include second base layer 108. Second base layer 104 and second base may include a conductive material. The conductive material may include copper, aluminum or any other suitable material.

A dielectric layer (not shown) may be disposed between first base layer 102 and first base layer 106. The dielectric layer may be an electrical insulator. The dielectric layer may insulate between first base layer 102 and first base layer 106. First base layer 102 and first base layer 106 may include vias 112. Vias 112 may provide electrical current flow channels. Vias 112 may enable current to be transmitted from first base layer 106 to first base layer 102.

The dielectric layer (not shown) may be disposed between second base layer 104 and second base layer 108. The dielectric layer may insulate between second base layer 104 and second base layer 108. Second base layer 104 and second base layer 108 may include vias 114. Vias 114 may provide electrical current flow channels. Vias 114 may enable current to be transmitted from second base layer 108 to second base layer 104.

The first base may be a support. The support may provide stiffness and rigidity to light tape 100. The first base may have a first polarity. The second base may be a support. The support may provide stiffness and rigidity to light tape 100. The second base may have a second polarity. The second polarity may be different from the first polarity. The first and second polarities may change based on different inputs from a user.

The first and second conductive poles may provide power to LEDs (not shown) included in light tape 100. The LEDs may be disposed across light tape 100. LEDs included in light tape 100 may include first CCT LEDs and second CCT LEDs. The first CCT LEDs and second CCT LEDs may include any suitable CCT as listed in Table 1. First CCT LEDs may be disposed, in a first direction, across light tape 100. Second CCT LEDs may be disposed, in a second direction, across light tape 100. For example, anodes of first CCT LEDs may be disposed on the first base and cathodes of first CCT LEDs may be disposed on the second base, while anodes of second CCT LEDs may be disposed on the second base and cathodes of second CCT LEDs may be disposed on the first base.

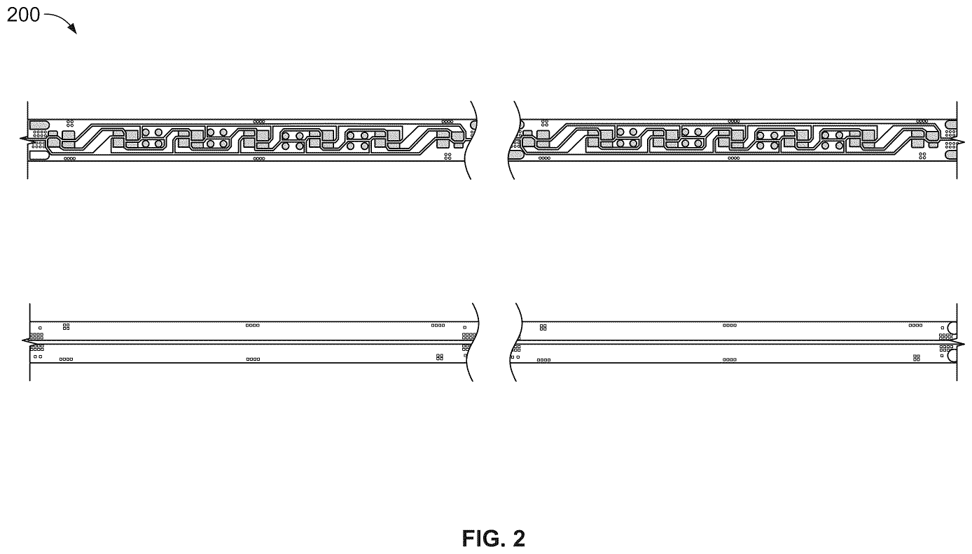

FIG. 2 shows an illustrative schematic in accordance with the principles of this invention. FIG. 2 shows illustrative light tape 200. Light tape 200 may have one or more features in common with light tape 100.

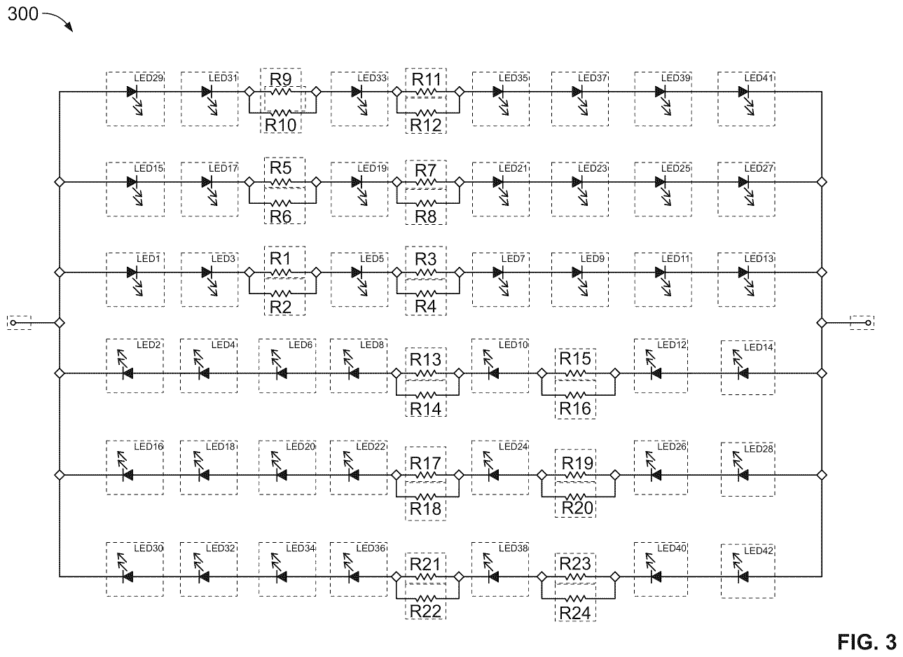

FIG. 3 shows an illustrative schematic in accordance with the principles of this invention. FIG. 3 shows illustrative LED array 300. LED array 300 may include first CCT LEDs, second CCT LEDs and resistors. LED array 300 may be disposed across the first conductive pole and the second conductive pole of light tapes 100 and 200 (in FIGS. 1 and 2).

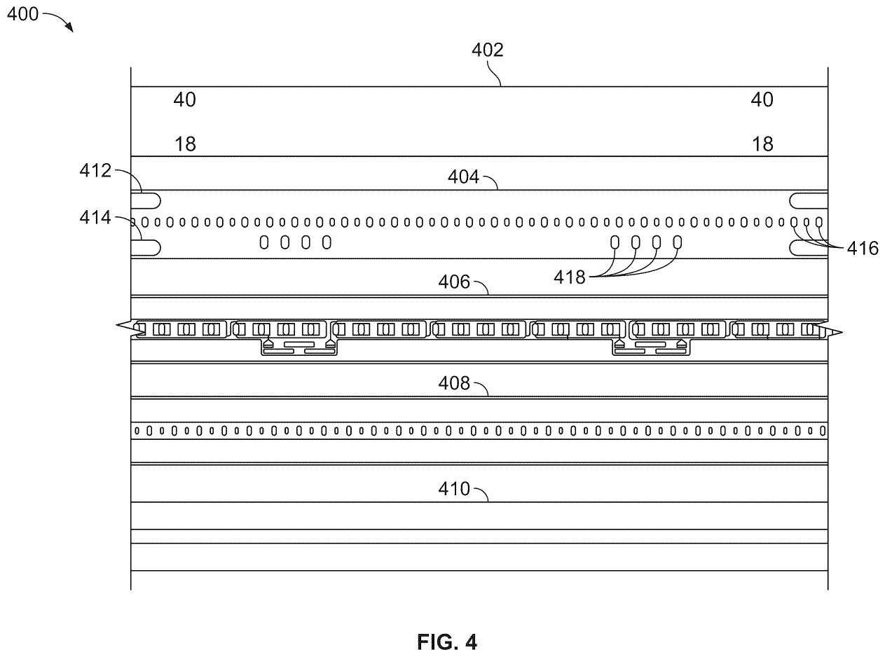

FIG. 4 shows an illustrative schematic in accordance with the principles of this invention. FIG. 4 shows illustrative light tape 400. Light tape 400 may be a chip on board (“COB”) light tape. Light tape 400 may include PCB layer 410. Light tape 400 may include copper layer 408. Light tape 400 may include solder mask 406. Light tape 400 may include LED layer 404. LED layer 404 may include LEDs 416. LED layer 404 may include resistors 418. Light tape 400 may include silk screen 402. Light tape 400 may include any other suitable layers.

Light tape 400 may include terminals 412 and 414. Terminals 412 and 414 may receive power. The power may be used to illuminate LEDs 416. Terminal 412 may receive power having a first polarity. The second terminal may receive power having a second polarity. The second polarity may be different from the first polarity. The first and second polarities may change based on different inputs from a user.

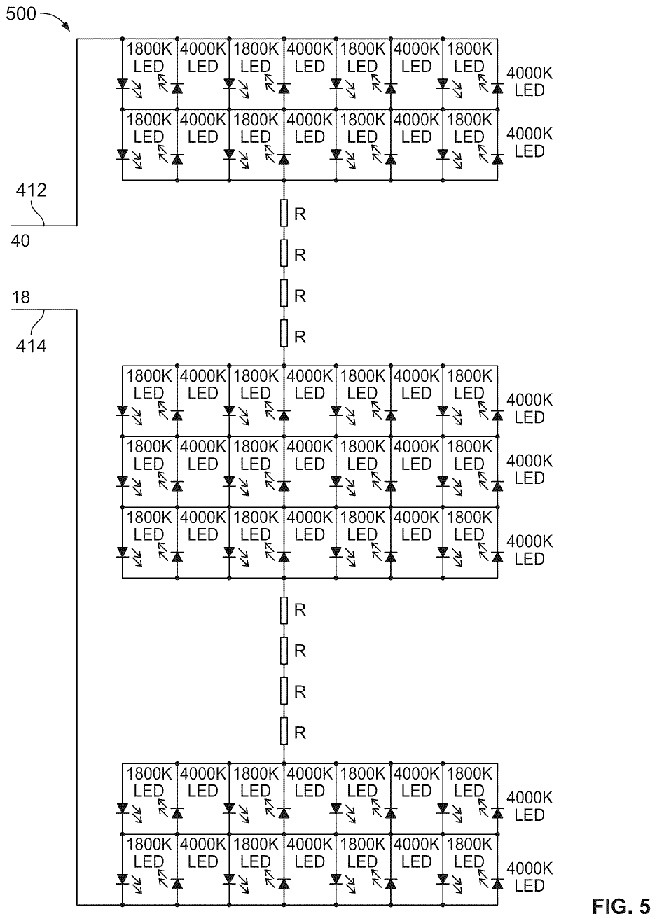

FIG. 5 shows an illustrative schematic in accordance with the principles of this invention. FIG. 5 shows illustrative LED array 500. LED array 500 may include first CCT LEDs, second CCT LEDs and resistors. LED array 500 may be disposed on light tape 400.

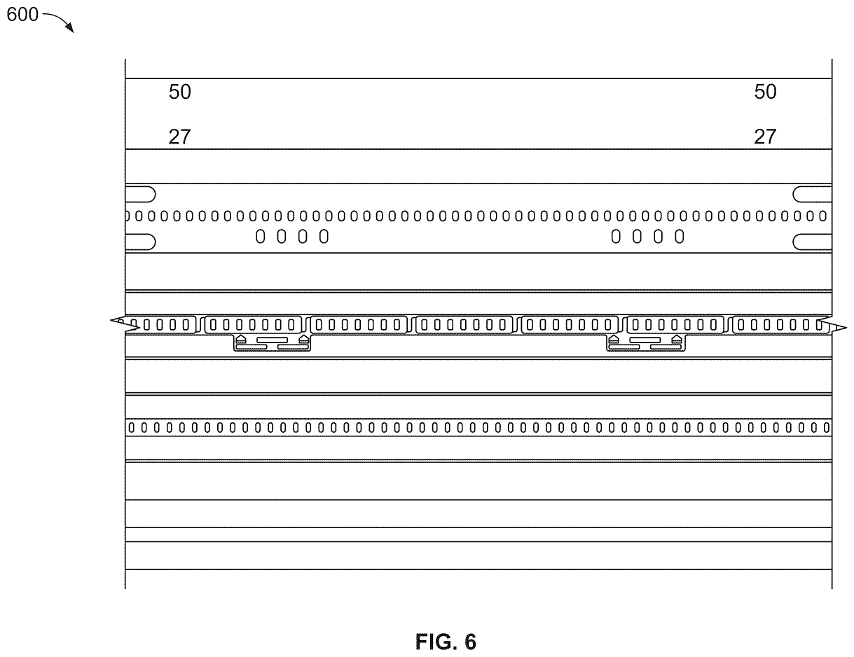

FIG. 6 shows an illustrative schematic in accordance with the principles of this invention. FIG. 6 shows illustrative light tape 600. Illustrative light tape 600 may have one or more features in common with light tape 400.

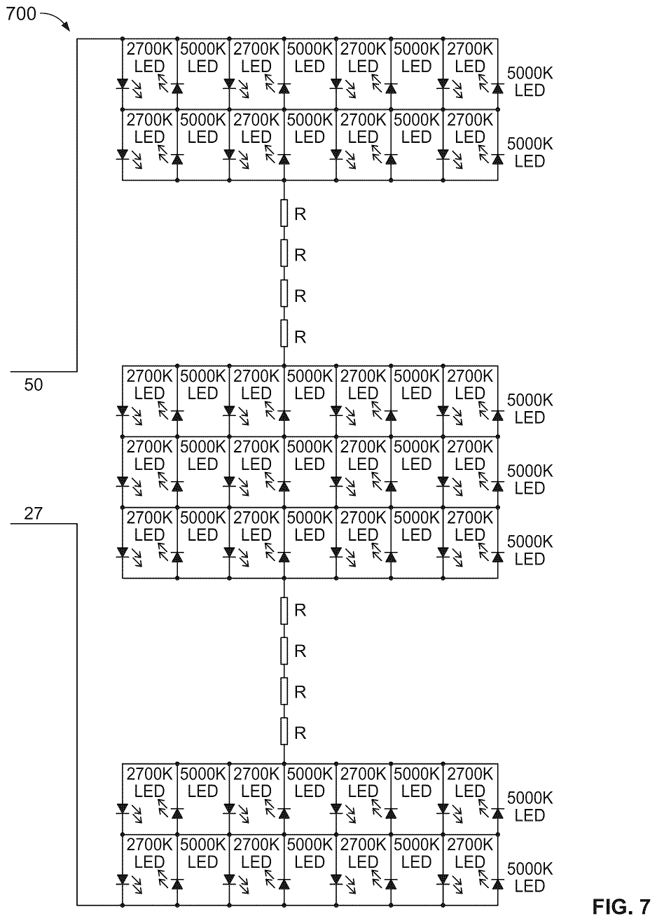

FIG. 7 shows an illustrative schematic in accordance with the principles of this invention. FIG. 7 shows illustrative LED array 700. LED array 700 may have one or more features in common with LED array 500. LED array 700 may be disposed on light tape 600.

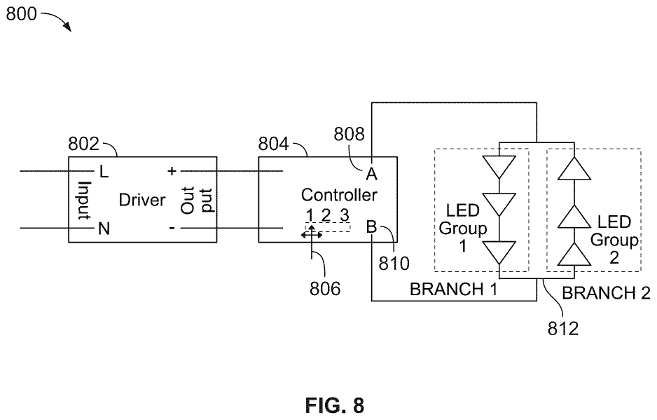

FIG. 8 shows illustrative architecture 800 for providing mixed CCT lighting. Architecture 800 may be included in one or more of light tapes 100, 200, 400, 600 and 1400. Architecture 800 may include illustrative driver 802. Architecture 800 may include illustrative controller 804. Architecture 800 may include illustrative LED branches 1 and 2. Branch 1 may include first CCT LEDs (“LED group 1”). Branch 2 may include second CCT LEDs (“LED group 2”). The second CCT may be different from the first CCT. The first CCT and the second CCT may include any suitable CCT as listed in Table 1.

Controller 804 may include user-operable CCT selector 806. Selector 806 may have two or more settings, e.g., “1,” “2,” “3,” and any other suitable setting. The different settings may correspond to different outputs at poles 808 (“A”) and 810 (“B”). Architecture 800 may include illustrative LED module circuit 812. Selector 806 may be mechanically operable. Selector 806 may be electronically operable. Selector 806 may be operable electronically by software. Selector 806 may be operable remotely from a mobile device. Selector 806 may be operable wirelessly.

When selector 806 is in position “1”, controller 804 may control pole A to be the “+” pole and pole B to be the “−” pole. When controller 804 controls pole A to be the “+” pole and pole B to be the “−” pole, LED group 1 may be on, and LED group 2 may be off. At this time, the color temperature of light emitted by LED module circuit 812 may be the LED group 1 color temperature.

When selector 806 is in position “3”, controller 804 may control pole A to be the “−” pole and pole B to be the “+” pole. When controller 804 controls pole A to be the “−” pole and pole B to be the “+” pole, LED group 1 may be off, and LED group 2 may be on. At this time, the color temperature of light emitted by LED module circuit 812 may be LED 2 color temperature.

When selector 806 is in position “2”, controller 804 may control pole A for a first fraction of the time to be the “+” pole and for a second fraction of the time to be the “−” pole. Pole B may have polarity opposite that of pole A. When the positive and negative switching frequency is large enough, the color temperature of the fixture may be a mixture of the CCTs of LED group 1 and LED group 2. The mixed CCT may be a CCT value in a range listed in Table 1. The mixed CCT may be 3,500°K, for example.

A switching cycle, during which LED group 1 are illuminated for a first fraction and LED group 2 are illuminated for a second fraction, may have any suitable duration.

The first and second fractions may be the same. The first and second fractions may be different. A sum of the first and second fractions may be about 1. The first and second fractions may be sized to result in a desired CCT mix between LED group 1 and LED group 2. The first and second fractions may include fractions as listed in Table 2.

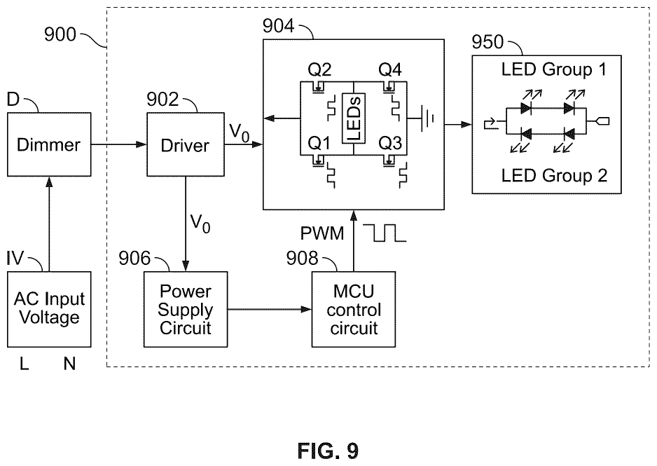

FIG. 9 shows an illustrative logic diagram of color temperature regulating circuit 900. The color temperature regulating circuit may have one or more features in common with architecture 800. Color temperature regulating circuit 900 may be included in one or more of light tapes 100, 200, 400 and 600.

Circuit 900 may include driver 902. Circuit 900 may include color switching unit 904. Circuit 900 may include power supply circuit 906. Circuit 900 may include MCU control circuit 908.

Circuit 900 may receive a dimming signal from dimmer D. Dimmer D may include any suitable dimmer. Dimmer D may be a commercially available dimmer switch. Dimmer D may include a forward phase cut dimmer (e.g., magnetic low voltage (“MLV”) or TRIAC). Dimmer D may include a reverse phase dimmer (e.g., electronic low voltage (“ELV”)). Dimmer D may include a 0-10V dimmer. Dimmer D may be a wall-mounted dimmer switch.

AC power may enter dimmer D from L and N phase lines from standard AC Input Voltage IV.

Driver 902 may be any suitable driver. Table 3 lists illustrative drivers for sections of different lengths. A fixture having one or more sections may have one or more drivers for each section.

TABLE 3
Illustrative drivers (902) for different section lengths.
Illustrative drivers (902) for different chain lengths

| | Illustrative driver (902), available |
|---|---|
| Number of | from Dongguan AMC Lighting Co., |
| sections (N) | Ltd., Dongguan City, China |
| 6 | 4LD0350U2238CP0350 |
| 8 | 4LD0500U2238DP0500 |
| 14 | 4LD0700U2240DP0700 |
| 18 | 4LD1050U2038AP1050 |
| 22 | 4LD1400U2036AP1400 |
| 40 | 2 * 4LD1050U2038AP1050 |
| Other suitable numbers | Other suitable drivers |

Driver 902 may output voltage Vₒ. Vₒ may have a variable voltage. Vₒ may have a constant current. Driver 902 may provide Vₒ to color switching unit 904. Driver 902 may provide Vₒ to microcontroller unit (“MCU”) control circuit 908. Color switching unit 904 may include LED module circuit 950. MCU control circuit 908 may control the flow of current through LED group 1 and LED group 2 by controlling the states of MOSFETs Q1, Q2, Q3 and Q4 in color switching unit 904.

Power supply circuit 906 may provide a constant voltage to MCU control circuit 908.

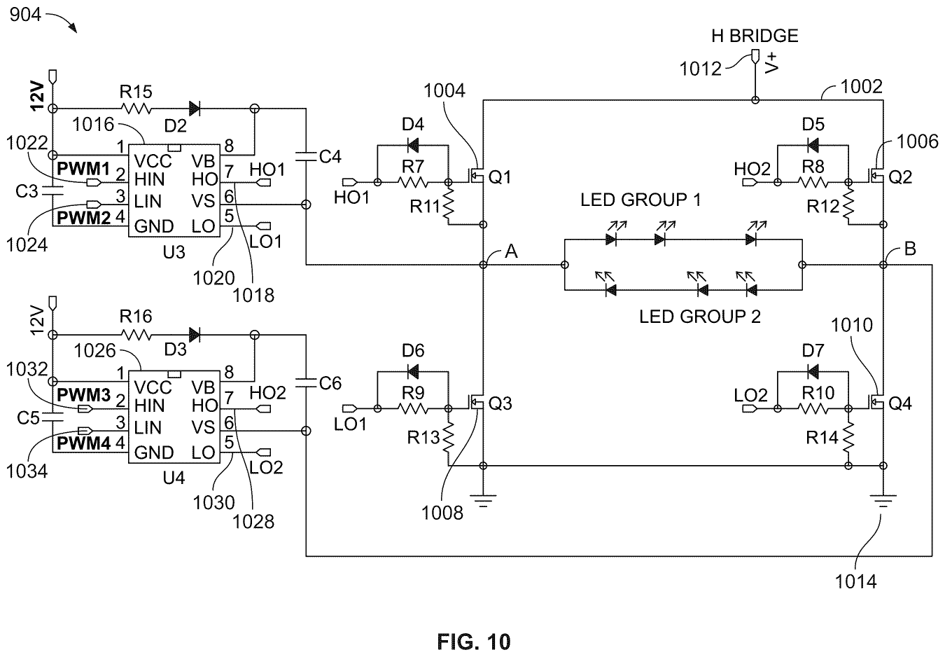

FIG. 10 shows illustrative color switching unit 904. Color switching unit 904 may include H-bridge 1002. H-bridge 1002 may include MOSFET 1004 (Q1). H-bridge 1002 may include MOSFET 1006 (Q2). H-bridge 1002 may include MOSFET 1008 (Q3). H-bridge 1002 may include MOSFET 1010 (Q4). Voltage 1012 (V+), relative to ground 1014, may be applied to H-bridge 1002. Voltage 1012 (V+) may be received from power supply circuit 906. Voltage 1012 (V+) may power LED group 1 and LED group 2. MOSFETs 1004 (Q1), 1006 (Q2), 1008 (Q3) and 1010 (Q4) may direct lighting power from voltage 1012 (V+).

In a first state, MOSFETs 1004 (Q1) and 1010 (Q4) may be open (conducting) and MOSFETs 1006 (Q2) and 1008 (Q3) may be closed (non-conducting). In the first state, output pole A may be HIGH and output pole B may be LOW. Current may flow through the LED group 1, which are aligned to conduct from output pole A to output pole B when output pole A is HIGH, and not through the LED group 2, which are aligned with polarity opposite LED group 1.

In a second state, MOSFETs 1006 (Q2) and 1008 (Q3) may be open and MOSFETs 1004 (Q1) and 1010 (Q4) may be closed. In the second state, output pole B may be HIGH and output pole A may be LOW. Current may flow through the LED group 2, which are aligned to conduct from output pole B to output pole A when output pole B is HIGH, and not through the LED group 1, which are aligned with polarity opposite the LED group 2.

In a third state, H-bridge 1002 may alternate between the first and second states. The alternation may have a duty cycle. The alternation may be based on fractions of the duty cycle. The first, second and third states may correspond to positions of selector 806 (in FIG. 8).

Color switching unit 904 may include integrated circuit (“IC”) 1016 (U3). IC 1016 (U3) may output PWM voltages 1018 (H01) and 1020 (L01), which may control, respectively MOSFETs 1004 (Q1) and 1008 (Q3). IC 1016 (U3) may receive signal 1022 (PWM1) and signal 1024 (PWM2). IC 1016 (U3) may receive signal 1022 (PWM1) at pin HIN. IC 1016 (U3) may receive signal 1024 (PWM2) at pin LIN.

Color switching unit 904 may include integrated circuit (“IC”) 1026 (U4). IC 1026 (U4) may output PWM voltages 1028 (H02) and 1030 (L02), which may control, respectively MOSFETs 1006 (Q2) and 1010 (Q4). IC 1026 (U4) may receive signal 1032 (PWM3) and signal 1034 (PWM4). IC 1016 (U3) may receive signal 1032 (PWM3) at pin HIN. IC 1016 (U3) may receive signal 1034 (PWM4) at pin LIN.

The sum of signals 1022 (PWM1), 1024 (PWM2), 1032 (PWM3) and 1034 (PWM4) may correspond to a dimming level set by dimmer D. The difference of signals 1022 (PWM1) and 1024 (PWM2) may correspond to a difference in intensity of light emission from LED group 1 and LED group 2. The difference of signals 1032 (PWM3) and 1034 (PWM4) may correspond to a difference in intensity of light emission from LED group 1 and LED group 2. The difference may be based on an OFF condition in one of LED group 1 and LED group 2. The difference may be based on a difference of ON conditions between LED group 1 and LED group 2.

IC 1016 (U3) and IC 1026 (U4) may have similar or identical pin configurations. The inputs of signals 1022 (PWM1) and 1024 (PWM2) to IC 1026 (U4) pins HIN and LIN may be the reverse of the inputs of signals 1032 (PWM3) and 1034 (PWM4) to IC 1016 (U3) pins HIN and LIN. Current flow may be apportioned between LED group 1 and LED group 2.

Input of signals 1022 (PWM1) and 1024 (PWM2) to IC 1026 (U4) and input of signals 1032 (PWM3) and 1034 (PWM4) to IC 1016 (U3) may enable individual control of H-bridge 1002. Signals 1022 (PWM1) and 1024 (PWM2) may be used to control MOSFET 1004 (Q1) and MOSTFET 1008 (Q3). Signals 1032 (PWM3) and 1034 (PWM4) may be used to control MOSFET 1006 (Q2) and MOSFET 1010 (Q4). Receiving four PWM signals may improve color temperature accuracy when LEDs included in LED group 1 and LED group 2 are dimmed to a low level.

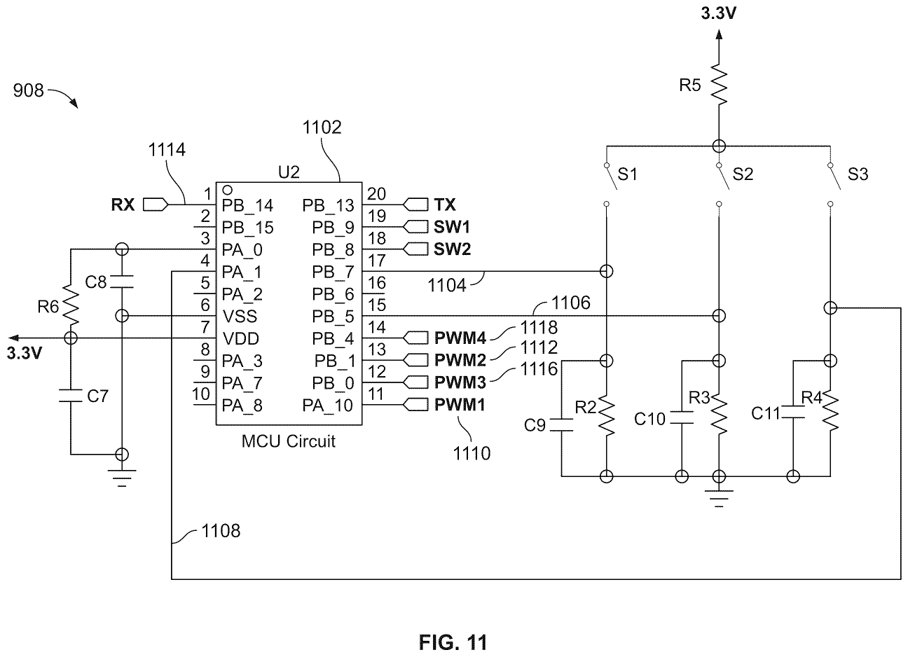

FIG. 11 shows illustrative MCU control circuit 908. MCU control circuit 908 may include MCU 1102 (U2). MCU 1102 (U2) may receive switch inputs 1104, 1106 and 1108, which may correspond to positions 1, 2 and 3 of selector 806. When selector 806 is at position 1, MCU 1102 (U2) may output a high duty cycle PWM signal at pin 1110 (PA_10; PWM1) and pin 1118 (PB_4; PWM4). When selector 806 is at position 1, MCU 1102 (U2) may output a low duty cycle PWM signal at pin 1112 (PB_1; PWM2) and at pin 1116 (PB_0; PWM3). The low duty cycle PWM signal may correspond to an OFF condition in LED group 2.

When selector 806 is at position 2, MCU 1102 (U2) may output a low duty cycle PWM signal at pin 1110 (PA_10; PWM1) and pin 1118 (PB_4; PWM4). When selector 806 is at position 2, MCU 1102 (U2) may output a high duty cycle PWM signal at pin 1112 (PB_1; PWM2) and at pin 1116 (PB_0; PWM3). The low duty cycle PWM signal may correspond to an OFF condition in LED group 1.

When selector 806 is at position 3, MCU 1102 (U2) may switch the high and low duty cycles between pins 1110 (PA_10; PWM1), 1112 (PB_1; PWM2), 1116 (PB_0; PWM3) and 1118 (PB_4; PWM4). The switch may be performed repeatedly at the switching cycle. This may cause alternating illumination between LED group 1 and LED group 2. The alternating illumination may provide illumination having a CCT that is a mixture of the first and second CCT.

MCU control circuit 908 may receive external control signal 1114 (Rx). Signal 1114 (Rx) may be processed by the MCU 1102 (U2) to obtain signals 1022 (PWM1), 1024 (PWM2), 1032 (PWM3) and 1034 (PWM4).

By controlling the turn-on time of the MOSFETs 1004 (Q1)/1010 (Q4) and 1006 (Q2)/1008 (Q3), the brightness of the LED light sources included in LED group 1 and LED group 2 may be adjusted, so as to realize the adjustment of the CCT of LED light source.

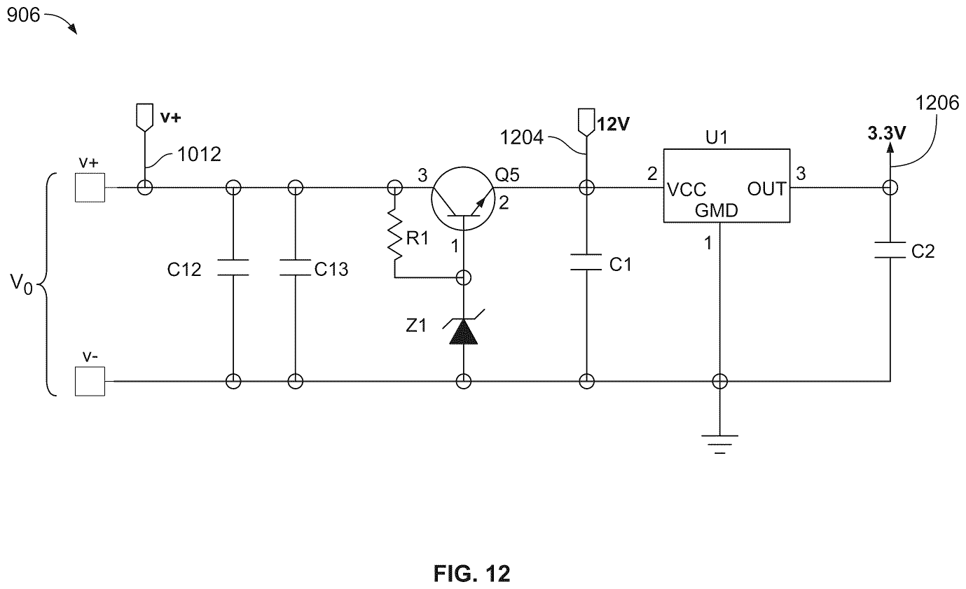

FIG. 12 shows illustrative power supply circuit 906. Power supply circuit 906 may receive voltage V₀. Power supply circuit 906 may provide voltage 1012 (V+), which may be used by color switching unit 904 to power LED group 1 and LED group 2. Power supply circuit 906 may provide voltage 1204 (12V), which may provide operational voltage for ICs 1016 (U3) and 1026 (U4). Power supply circuit 906 may provide constant voltage 1206 (5V), which may provide operational voltage for MCU 1102 (U2).

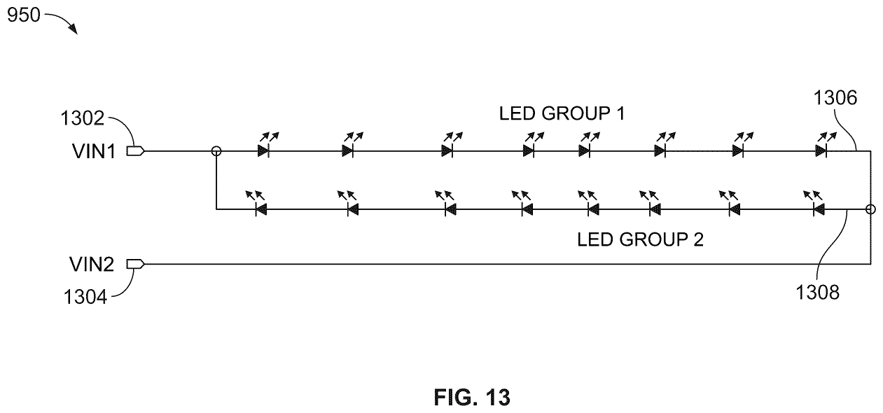

FIG. 13 shows illustrative LED module circuit 950. Circuit 950 may be implemented on a PCB in a light tape segment (shown in FIGS. 1 and 2).

LED module circuit 950 may include branch 1306. Branch 1306 may include one or more warm CCT LEDs. The warm CCT LEDs may correspond to LED Group 1 (shown in FIG. 8). Branch 1306 may receive voltage via input 1302 (VIN1) and input 1304 (VIN2). Input 1302 (VIN1) may correspond to pole A (shown in FIG. 8). Input 1304 (VIN2) may correspond to pole B (shown in FIG. 8).

LED module circuit 950 may include branch 1308. Branch 1308 may include one or more cool CCT LEDs. The cool CCT LEDs may correspond to LED Group 2. Branch 1308 may receive voltage via input 1302 (VIN1) and input 1304 (VIN2). Input 1302 (VIN1) may correspond to pole A (shown in FIG. 8). Input 1304 (VIN2) may correspond to pole B (shown in FIG. 8).

Table 4 lists illustrative parts that may be associated with one or more circuits described in FIGS. 8-12.

TABLE 4
Illustrative parts that may be associated with
one or more circuits described in FIGS. 8-12.

| Illustrative Part | Tag |
|---|---|
| Double-sided FR4 52*26*1.2 mm 2*5 continuous piece | |
| X7R SMD capacitors 2.2 uF/100 V, ±10%,125 °C(1206) | C13, C12 |
| Ultra-fast recovery diodes ES1JW 1 A/600 V SOD-123FL | D2, D3 |
| SMD switching diodes 1N4148W, 0.15 A/75 V, SOD-123 | D4, D5, D6, D7 |
| SMD regulator diodes 12 V ± 2%/MM1ZB12 0.5 W SOD-123 | Z1 |
| X7R SMD capacitors 1 uF/50 V, ±10%, 125 °C(0805) | C1, C3, C5, C7 |
| X7R SMD capacitors 1 nF/50 V, ±10%, 125 °C(0805) | C9, C10, C11 |
| X7R SMD capacitors 100 nF/50 V, ±10%, 125 °C(0805) | C4, C6 |
| X7R SMD capacitors 100 nF/50 V, ±10%, 125 °C(0603) | C8 |
| ⅛ W chip resistor 20K ± 1%(0805) | R1, R2, R3, R4 |
| ⅛ W SMD resistors 3.3 R ± 1%(0805) | R5, R6 |
| ⅛ W chip resistor, 47 KΩ ± 1% (0805). | R11, R12, R13, R14 |
| ⅛ W SMD resistors 5.10Ω ± 1%(0805) | R7, R8, R9, R10 |
| ⅛ W SMD resistors 1K ± 1%(0805) | R16 |
| 1/10 W SMD resistors 1K ± 1%(0603) | R15 |
| SMD voltage stabilizing IC LD1117A, 3.3 V, SOT-89 | U1 |
| SMD IC ME32S003AF6P7 SS0P-20 panel mounted RoHS | U2 |
| SMD IC ID2006 SOIC8 RoHS | U3, U4 |
| SMD N-MOSFET 15N10, TO-252 | Q1, Q2, Q3, Q4 |
| SMD NPN transistor 2SD1760U_SOT-89_60 V/3 A | Q5 |
| SMD TVS tubes 60 V/600 W(SMB) SMBJ60A | TV1 |
| 18# blue Teflon wire length 200 full peel 11 immersed in tin 3 | |
| 18# brown Teflon wire length 200 full peel 11 immersed in tin 3 | |
| 18# red Teflon wire is 200 long, half stripped 13/immersed in tin 3 | |
| 18# black Teflon wire length 200, half stripped 13/immersed in tin 3 | |
| Three-position toggle switch ZYC-2301G2 BK | |
| Other illustrative parts | |

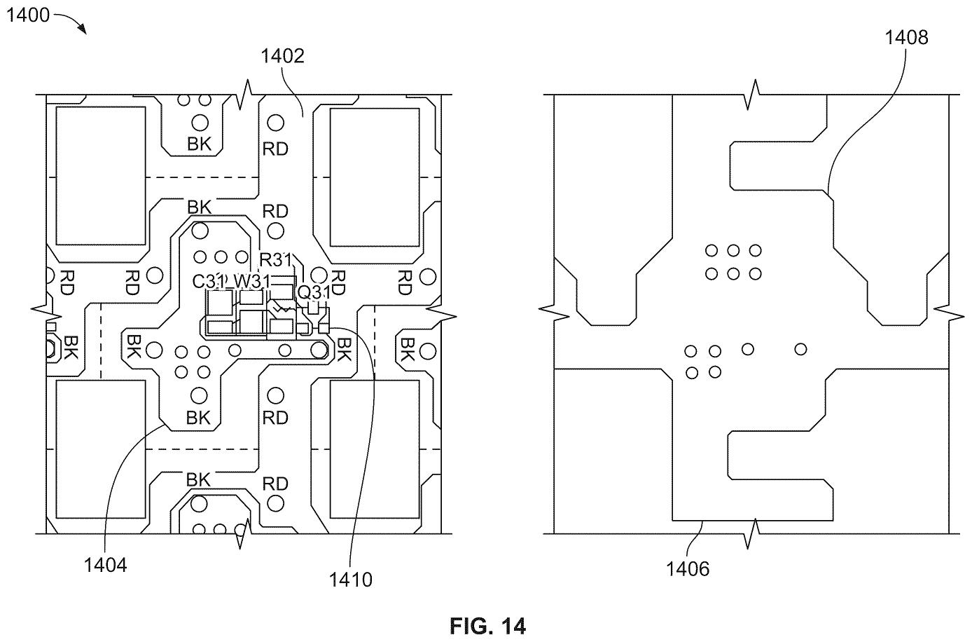

FIG. 14 shows an illustrative schematic in accordance with the principles of this invention. FIG. 14 shows illustrative section of light tape 1400. Light tape 1400 may include a light tape sheet. The light tape sheet may include one or more sections.

Light tape 1400 may include first conductive support 1402. Light tape 1400 may include second conductive support 1404. First conductive support 1402 may have a first polarity. Second conductive support 1404 may have a second polarity. The second polarity may be different from the first polarity. The first polarity and the second polarity may change in response to different inputs from a user.

First conductive support 1402 and second conductive support 1404 may include conductive material, such as, copper, aluminum or any other suitable conductive material. Light tape 1400 may include conductive layer 1406. Conductive layer 1406 may include conductive material, such as, copper, aluminum or any other suitable conductive material. Light tape 1400 may include a dielectric layer. The dielectric layer may include any suitable insulating material. The dielectric layer may be disposed to insulate conductive layer 1406 from first conductive support 1402 and second conductive support 1404.

Conductive layer 1406 may include vias 1408. Vias 1408 may include current flow channels. Vias 1408 may enable current to be transmitted from conductive layer 1406 to second conductive support 1404.

First conductive support 1402 and second conductive support 1404 may provide power to LEDs (not shown) included in light tape 1400. The LEDs may be disposed across first conductive support 1402 and second conductive support 1404. LEDs included in light tape 400 may include first CCT LEDs and second CCT LEDs. The first CCT LEDs and second CCT LEDs may include any suitable CCT as listed in Table 1. First CCT LEDs may be disposed, in a first direction, across first conductive support 1402 and second conductive support 1404. Second CCT LEDs may be disposed, in a second direction, across first conductive support 1402 and second conductive support 1404.

In each section, an anode of a first CCT LEDs may be disposed on the first conductive support 1402 and a cathode of the first CCT LED may be disposed on second conductive support 1404, while an anode of a second CCT LED may be disposed on second conductive support 1404 and a cathode of the second CCT LED may be disposed on first conductive support 1402. A resistor may also be disposed across first conductive support 1402 and second conductive support 1404. Each section may also include one or more Zener diodes 1410. Zener diodes 1410 may be used to increase the voltage range of the first CCT LED and the second CCT LED. Zener diodes 1410 may provide a fixed voltage drop in order to enable greater control of the brightness emitted by the first CCT LED and the second CCT LED. Zener diodes 1410 may provide a fixed voltage drop in order to enable greater control of the brightness emitted by the first CCT LED and the second CCT LED, especially when dimming at low levels.

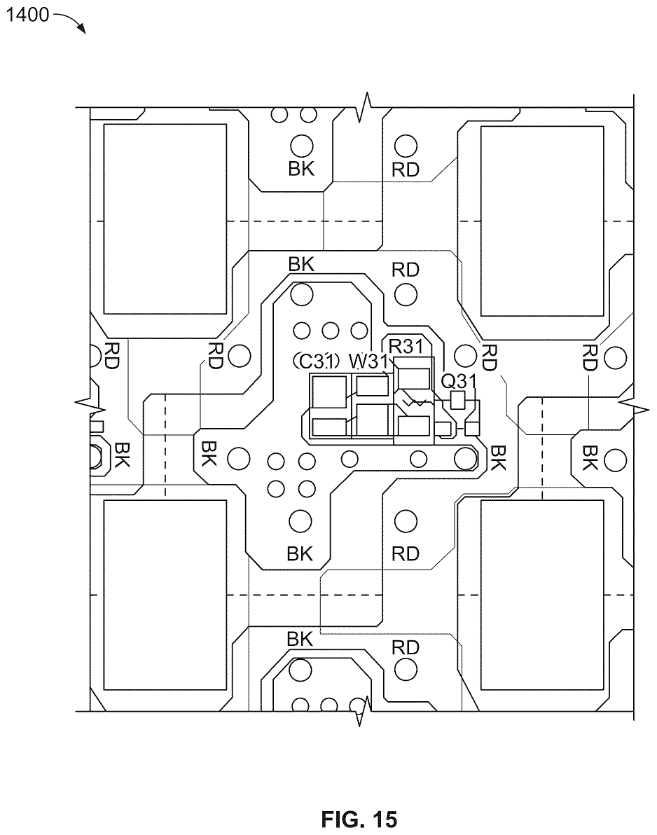

FIG. 15 shows an illustrative schematic in accordance with the principles of this invention. FIG. 14 shows first conductive support 1402 and second conductive support 1404 transposed on top of conductive layer 1406.

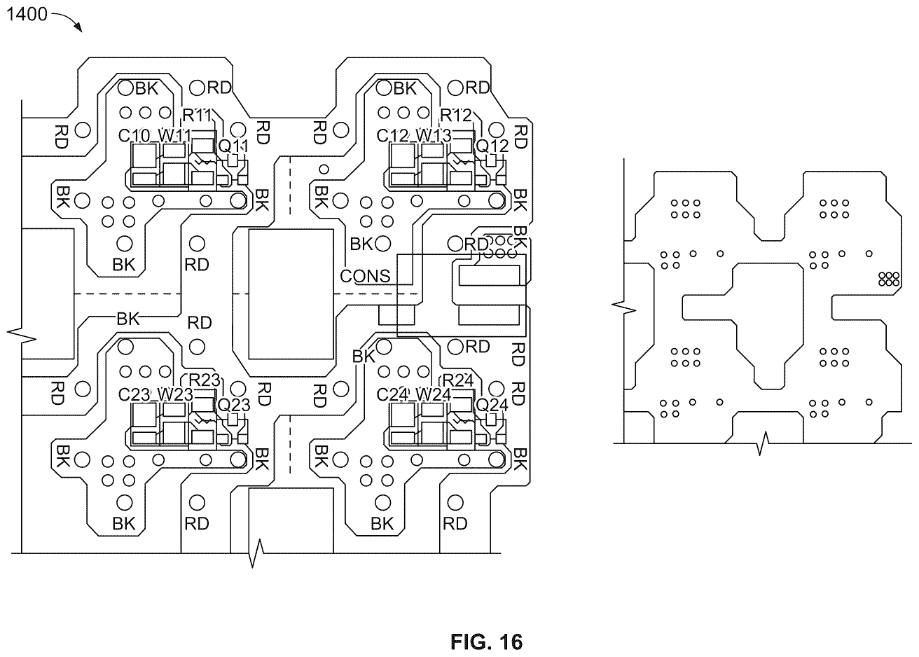

FIG. 16 shows an illustrative schematic in accordance with the principles of this invention. FIG. 16 shows additional sections of light tape 1400.

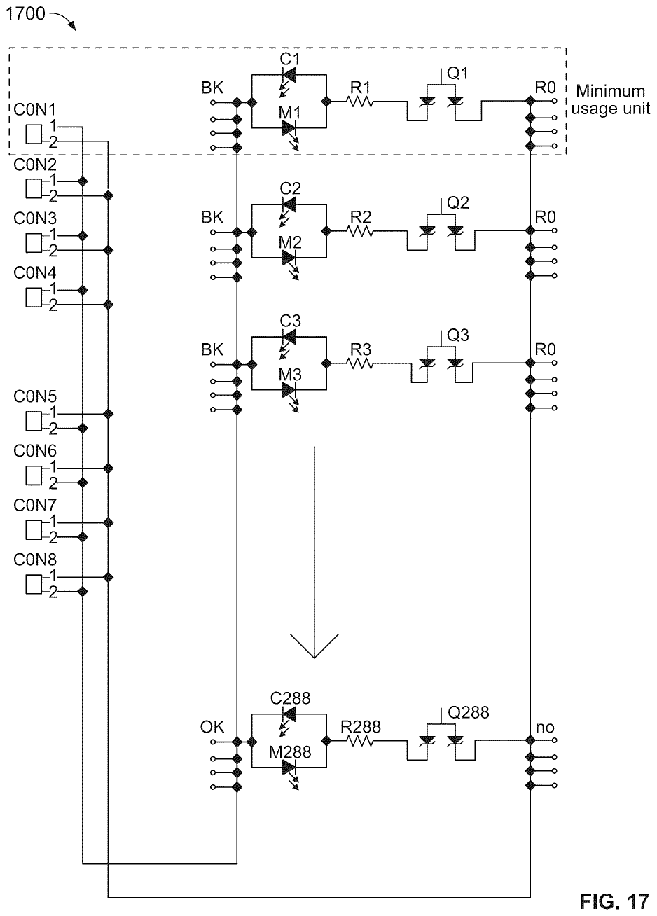

FIG. 17 shows an illustrative schematic in accordance with the principles of this invention. FIG. 17 shows LED array 1700. LED array 1700 may include one or more of a first CCT LED, a second CCT LED, a resistor and a Zener diode. LED array 1700 may be disposed on light tape 1400.

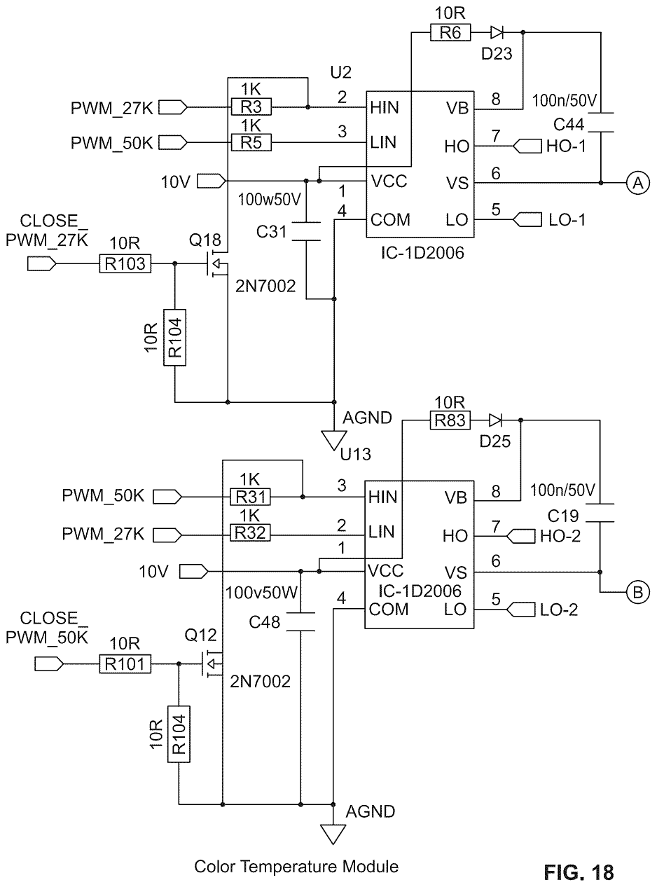

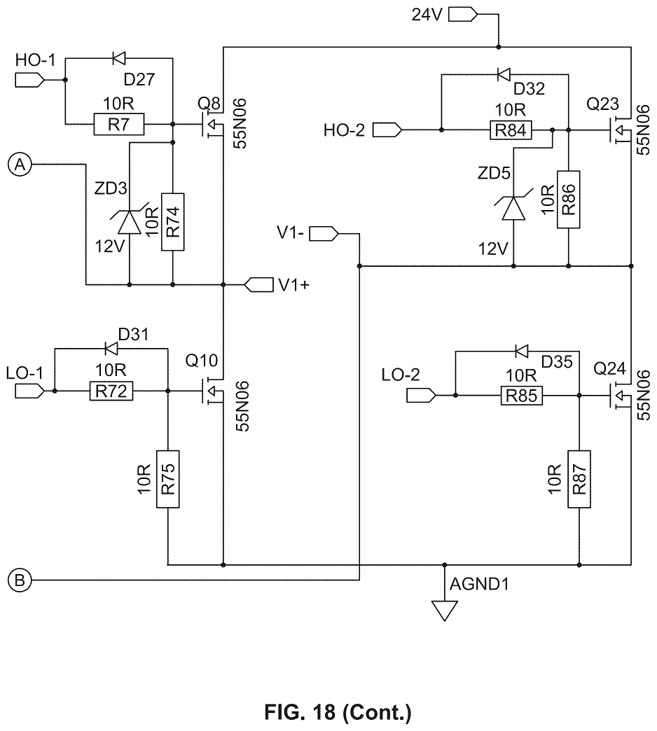

FIG. 18 shows an illustrative schematic in accordance with the principles of this invention. Implementing color temperature adjustment may include using two PWM channels and two general input/outputs (“IOs”). The two PWM channels may include color temperature 2700K: PWM_27K and color temperature 5000K: PWM_50K. Control of the two IOs may include: CLOSE_PWM_27K and CLOSE_PWM_50K.

Current from V1+ to V1− may be defined as positive. Current from V1− to V1+ may be defined as negative.

As shown in FIG. 18, the color temperature adjustment may be implemented using an H-bridge circuit. The light strip may be connected at positions V1+/V1−. ICs U9/U13 may drive the four MOSFETs of the H-bridge. The HIN pin of U9 may control Q8 (the PWM signal of U9's HIN and HO pins may be synchronized), and the LIN pin may control Q10 (the PWM signal of U9's LIN and LO pins may be synchronized). The HIN pin of U13 may control Q23, and the LIN pin may control Q24.

When dimming light to a low dimming level in a light tape that is set to 2700K-5000K, at 2700K, both LEDs may still be visible at the low dimming level. This means that both the 2700K and 5000K LEDs are on, causing a CCT shift. At 5000K, both LEDs may also remain on at the low diming level. This may also occur at other CCTs such as 3000K, 3500K, or any other CCT during the mixing process, and may continue to cause CCT shifts as the light dims. This may be because the light tape is driven by an H-bridge operating at around a 4 kHz frequency. At such a high frequency, a minimum current flows through the light tape, regardless of how low the PWM duty is.

For example, the driver may apply a 99% duty cycle to the 2700K LED and a 1% duty cycle to the 5000K LED. The driver is expected to deliver 2 mA to the 2700K and 0.02 mA to the 5000K. However, due to the high-frequency driving method, the actual current for the 2700K LED may be 2 mA, but for the 5000K LED, the actual current may be 0.5 mA.

If only 2700K is needed: The H-bridge driving the 5000K may be completely turned off. This way, the current would be 2 mA for the 2700K and 0 mA for the 5000K. This same approach may also be used when 5000K is needed, where the H-bridge driving the 2700K may be completely turned off.

In single color temperature mode (for example, color temperature 2700K), during a cycle, when PWM_27K (CH2) is high with a duty cycle of 99%, MOSFETs may be turned on simultaneously. The current may flow from Q8→V1+→V1−→Q24, causing LEDs 1→LED 13 to light up, while LEDs 2→LED 14 remain off. When PWM_50K is high with a duty cycle of 1%, and CLOSE_PWM_50K (CH4) is also high, Q12 (MOSFET) turns on, the HIN pin of IC U13 is low, and Q23 remains off. The current does not flow from Q23→V1−→V1+→Q10, so LEDs 1→LED 13 and LEDs 2→LED 14 do not light up.

IC U9 may control Q8 and Q10. During a cycle, when PWM_50K is high, Q10 may turn on, causing V1+ to be 0. The 10V power supply may charge capacitor C44 through R10/D23. When PWM_27K is high, Q10 may not turn on, and the capacitor C44 may discharge, which may drive Q8 to turn on. The voltage of V1+ may become 24V, and D23 may be reverse-biased and may not conduct.

In the dual color temperature mode, when PWM_27K is high during a cycle, MOSFETs Q8 and Q24 may be turned on simultaneously. The current may flow from Q8→V1+→V1−→Q24, causing LEDs 1→LED 13 (which have a color temperature of 2700K) to light up, while LEDs 2→LED 14 (which have a color temperature of 5000K) remain off. When PWM_50K is high, MOSFETs Q10 and Q23 may be turned on simultaneously. The current may flow from Q23→V1−→V1+→Q10, causing LEDs 1→LED 13 to turn off, while LEDs 2→LED 14 light up.

For any color mixing between 2701K and 4999K: The minimum dimming level may be raised. With the same 99% to 1% duty cycle, the current for the 2700K LED may be 20 mA and the current for the 5000K LED may be 0.6 mA. This same concept of driving the 2700K-5000K load type may also be applied to the 1800K-4000K load type. At low dimming levels, a ratio of LED current mixing may not be accurate. At the low dimming levels, switching frequencies and turn-on times may not be accurate. The power supply may be unable to provide accurate switching frequencies and turn-on times at low dimming levels. Accordingly, at low dimming levels, the lowest dimming level may be increased. For example, a user intending to dim down to 0.1%, may only be able to dim to 1%. Increasing the lowest dimming level, may enable the ratio of LED current mixing to be accurate.

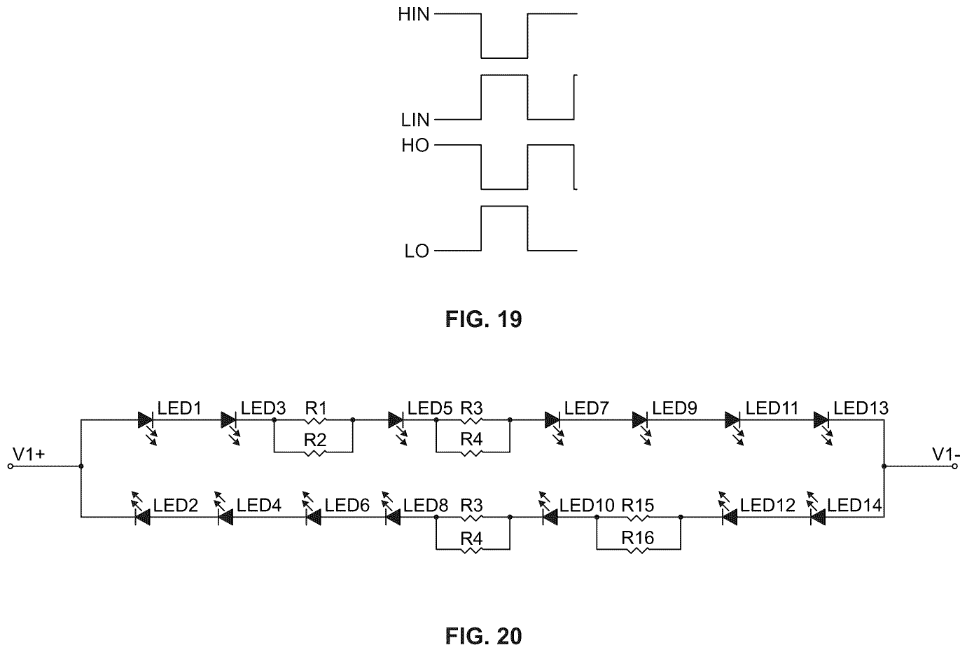

FIG. 19 shows an illustrative schematic in accordance with the principles of this invention. The PWM signals of PWM_27K and PWM_50K may be complementary, as shown in FIG. 19 with PWM_27K (HIN) and PWM_50K (LIN).

FIG. 20 shows an illustrative schematic in accordance with the principles of this invention.

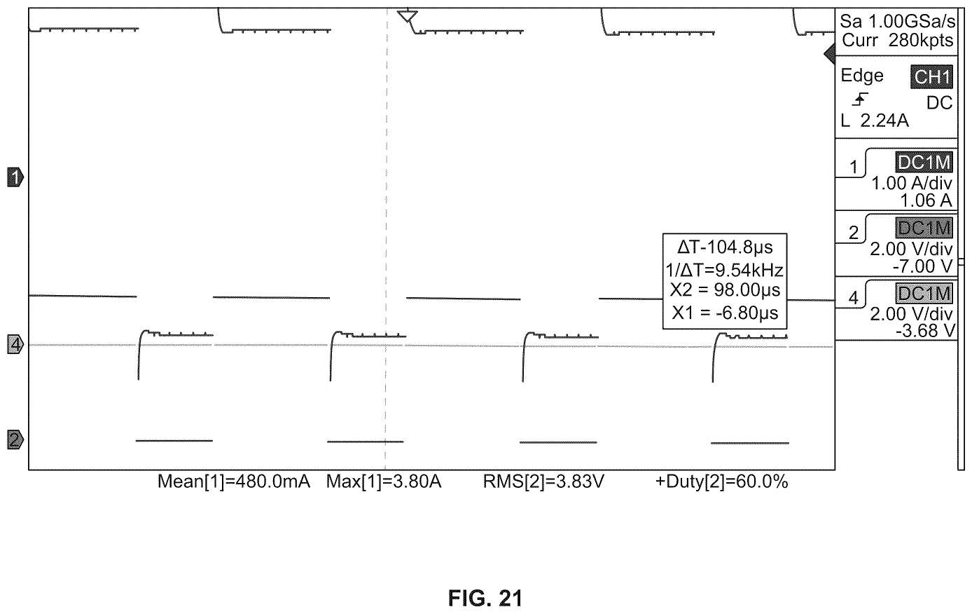

FIG. 21 shows an illustrative schematic in accordance with the principles of this invention.

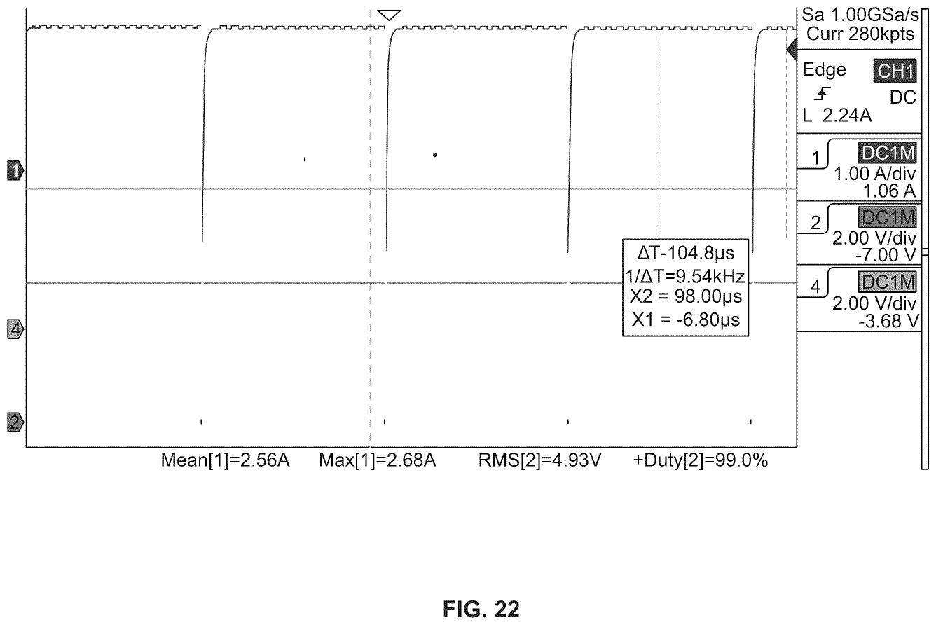

FIG. 22 shows an illustrative schematic in accordance with the principles of this invention.

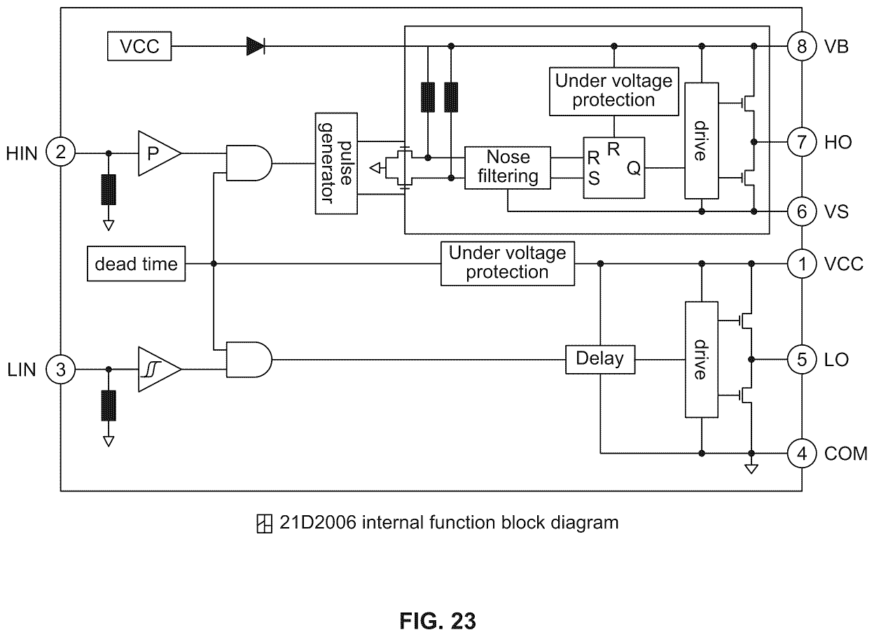

FIG. 23 shows an illustrative schematic in accordance with the principles of this invention.

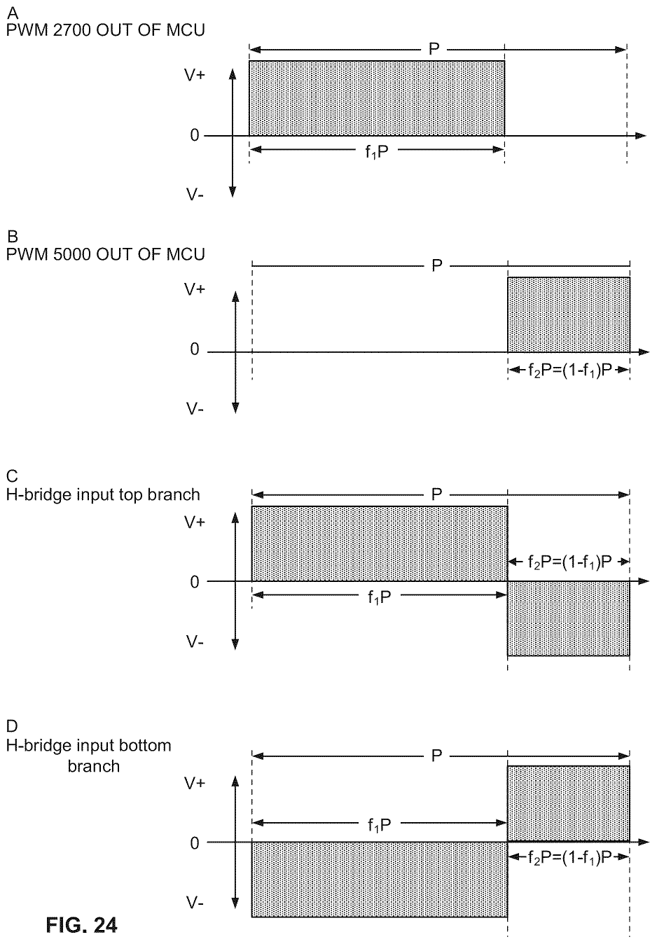

FIG. 24 shows schematically illustrative PWM signals A and B and PWM-derived signals C and D that may be used for achieving a mixed CCT in a fixture that includes high CCT LEDs and low CCT LEDs. A microcontroller may output PWM signal A for powering 2700 K LEDs. Signal A has period P and a duty cycle corresponding to f₁P, which is the fraction of P during which current will flow through the 2700 K LEDs.

The microcontroller may output PWM signal B for powering 5000 K LEDs. Signal B has period P and a duty cycle corresponding to f₂P, which is the fraction of P during which current will flow through the 5000 K LEDs.

Signals A and B may be provided to an H-bridge in which the 2700 K LEDs and the 5000 K LEDs have opposite polarity. In a first input to the H-bridge, signal B may be subtracted from signal A. This results in signal C, which drives the 2700 K LEDs for f₁P and the 5000 K LEDs for f₂P. Signal D may be the additive inverse of C and produce an analogous result.

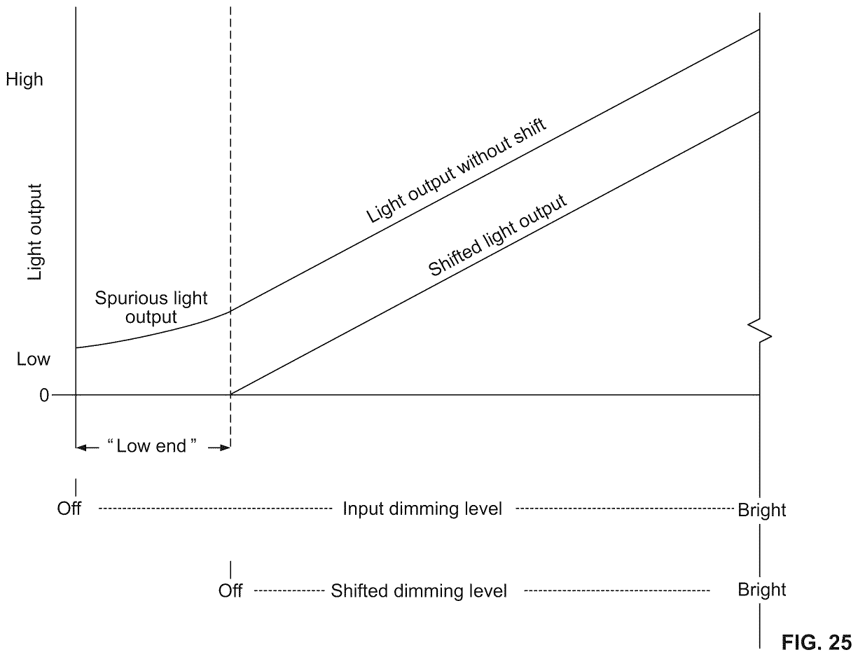

FIG. 25 shows a “low end” (meaning at a large dimming, but a low brightness) of a dimming curve for an LED light source. A user may apply an “input dimming level” using an available dimming controller, such as those available for 0-10 V, ELV, TRIAC dimming. In the “low end,” the light output may depart from a linear relationship with the dimming level because of edge distortion in a square wave signal, such as A-D. The apparatus and methods may include circuitry to produce a “shifted dimming level” that is offset to the right from the input dimming level. The result is that the “low end” excitation of MOSFETs that control current through the LEDs is not utilized. The “shifted light output” curve descends to zero light output in a more linear fashion than does the curve illustrating “light output without shift”. When mixing CCTs of different LEDs, this may reduce or eliminate variation of mixed CCT from a selected fraction when in the low end. When only a single CCT is selected, the non-selected CCT LED may be turned off. This may further reduce departure of light output from a desired light output curve.

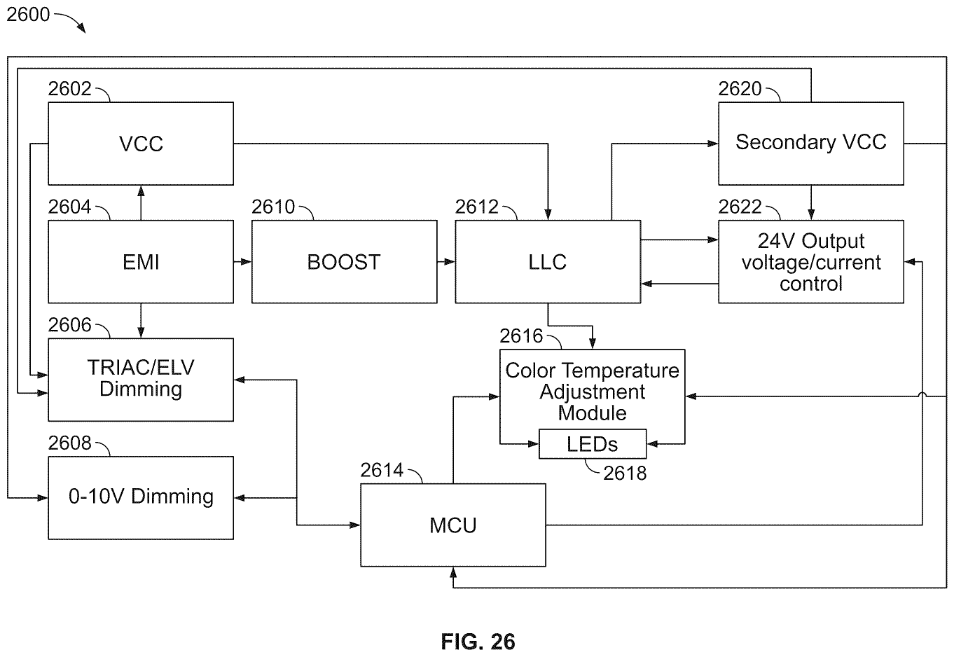

FIG. 26 shows illustrative circuit architecture 2600. Circuit architecture 2600 may be used to provide a mixed CCT in a fixture that includes high CCT LEDs and low CCT LEDs. Circuit architecture 2600 may be used to provide dimming when providing the mixed CCT.

Circuit architecture 2600 may include electromagnetic interference (“EMI”) circuitry 2604. EMI circuitry 2604 may receive line power. EMI circuitry 2604 may provide an output voltage.

EMI circuitry 2604 may transmit the output voltage to voltage common collector (“VCC”) circuitry 2602. VCC circuitry2602 may output a VCC voltage. EMI circuitry 2604 may provide the output voltage to boost circuitry 2610. Boost circuitry 2610 may boost the output voltage. Boost circuitry 2610 may transmit the boosted voltage to inductor-inductor-capacitor (“LLC”) circuitry 2612. VCC circuitry 2602 may transmit the VCC voltage to LLC circuitry 2612. LLC circuitry 2612 may step down the boosted voltage. LLC circuitry 2612 may provide the stepped down voltage to secondary VCC circuitry 2620.

LLC circuitry 2612 may provide the stepped down voltage to 24V output, voltage and current control circuitry 2622. LLC circuitry may provide the stepped down voltage to color temperature adjustment module 2616. Color temperature adjustment module 2616 may provide the stepped down voltage to plurality of LEDs 2618. Plurality of LEDs 2618 may include high CCT LEDs coupled in an antiparallel configuration with low CCT LEDs.

Circuit architecture 2600 may include microcontroller 2614. Microcontroller 2614 may transmit CCT mixing signals to color temperature adjustment module 2616. Microcontroller may receive dimming levels from TRIAC/ELV dimming circuitry 2606 and 0-10V dimming circuitry 2608. Microcontroller 2614 may transmit the dimming levels to 24V output, voltage and current control circuitry 2622.

24V output, voltage and current control circuitry 2622 may monitor current flowing through LEDs 2618. 24V output, voltage and current control circuitry 2622 may monitor the dimming level received from microcontroller 2614. 24V output, voltage and current control circuitry 2622 may modulate the voltage being transmitted through LLC circuitry 2612.

Secondary VCC circuitry 2620 may output a secondary VCC voltage. Secondary VCC may be provided to 24V output, voltage and current control circuitry 2622, microcontroller 2614, TRIAC/ELV dimming circuitry 2606 and 0-10V dimming circuitry 2608. VCC voltage may also be provided to TRIAC/ELV dimming circuitry 2606.

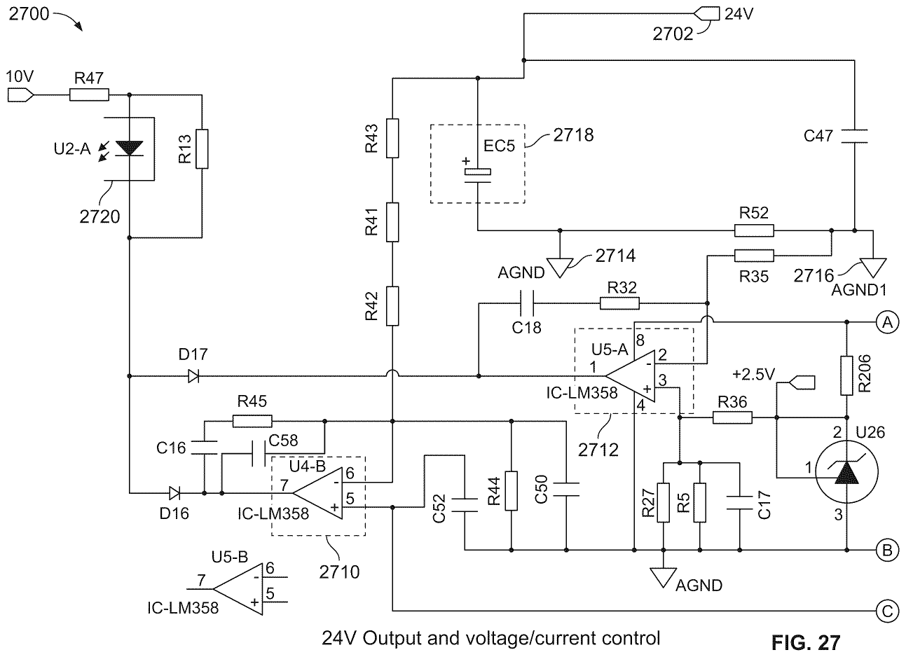

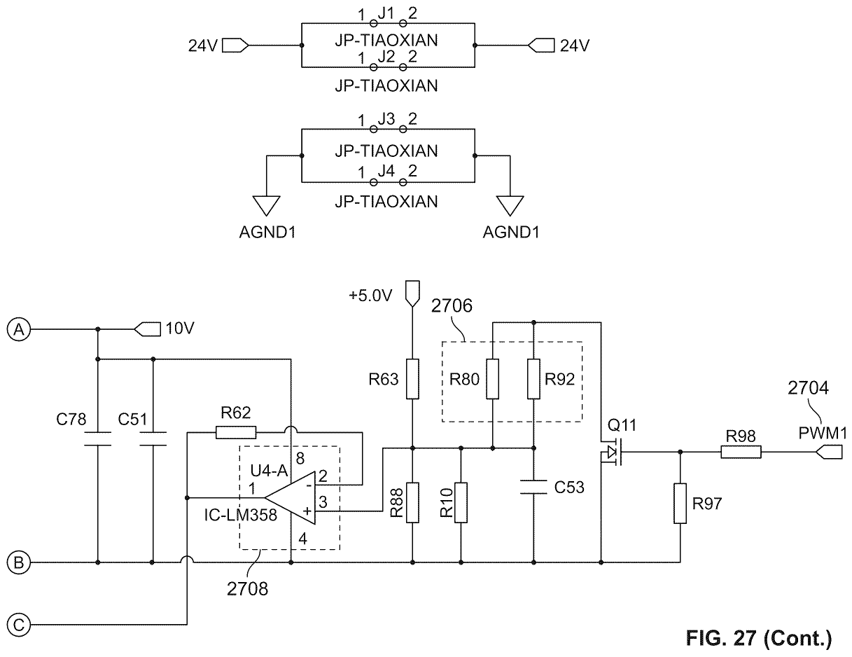

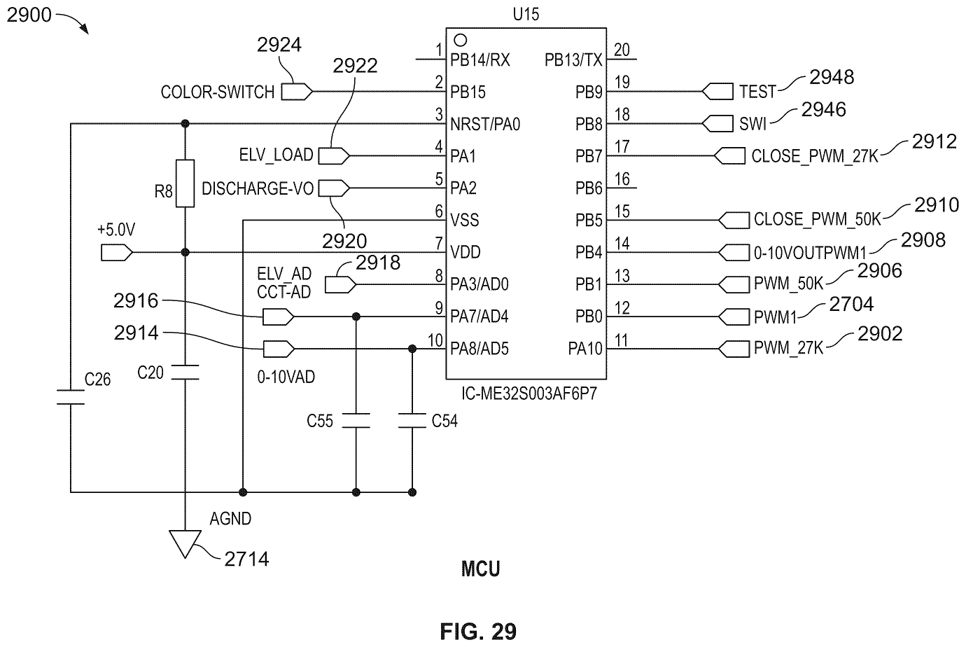

FIG. 27 shows illustrative 24V output and voltage/current control circuitry 2700. 24V output and voltage/current control circuitry 2700 may receive a dimming level via terminal 2704 (PWM1). The dimming level may be received from microcontroller 2900 (as shown in FIG. 29). 24V output and voltage/current control circuitry 2700 may include resistors 2706. Resistors 2706, MOSFET Q11 and surrounding circuitry may be used to shift the input dimming level. Resistors 2706, MOSFET Q11 and surrounding circuitry may be used to increase the input dimming level.

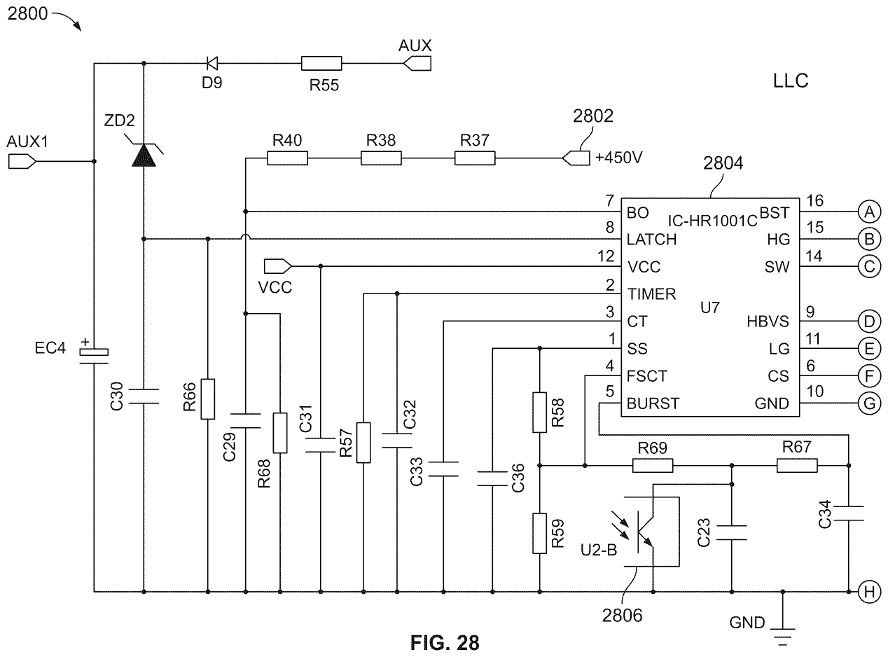

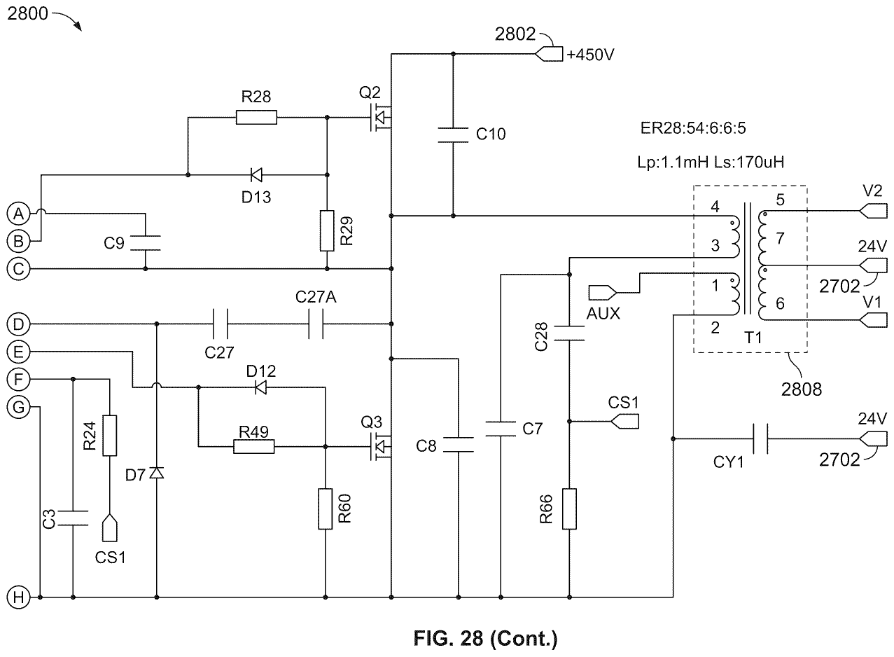

24V output and voltage/current control circuitry 2700 may include op-amp 2708. 24V output and voltage/current control circuitry 2700 may include op-amp 2710. Op-amps 2708 and 2710 may compare the increased dimming level with a threshold voltage. In response to a voltage corresponding to the increased dimming level being less than the threshold voltage, optocoupler input 2720 may transmit a signal. The signal may be transmitted via an LED. The signal may be transmitted to LLC circuitry 2800 (shown in FIG. 28). LLC circuitry 2800 may modulate output power in response to receiving the signal.

24V output and voltage/current control circuitry 2700 may include op-amp 2712. Op-amp 2712 may compare a voltage across ground 2714 and ground 2716 to a second threshold voltage. The voltage across ground 2714 and 2716 may be a proxy for a voltage across a plurality of LEDs receiving between terminal 2702 and ground 2716. In response to the voltage across ground 2714 and ground 2716 being greater than the second threshold voltage, optocoupler input 2720 may transmit a signal. The signal may be transmitted via the LED. The signal may be transmitted to LLC circuitry 2800 (shown in FIG. 28). LLC circuitry 2800 may modulate output power in response to receiving the signal.

24V output and voltage/current control circuitry 2700 may include e-cap 2718. In response to a drop in power being transmitted through terminal 2702, e-cap 2718 may release a stored charge. Energy associated with the stored charge may maintain operating voltage that is transmitted through terminal 2702. Energy associated with the stored charge may maintain the operating voltage that is transmitted through terminal 2702 from reducing below a minimum voltage level.

FIG. 28 shows illustrative LLC circuitry 2800. LLC circuitry 2800 may receive input voltage via terminal 2802. The input voltage may be a boosted voltage. The input voltage may be 450 VDC. LLC circuitry may include step-down transformer 2808. Step-down transformer 2808 may step down the boosted voltage. Step-down transformer 2808 may provide the operating voltage. The operating voltage may be transmitted via terminal 2702. The power may be transmitted through terminal 2702.

LLC circuitry 2800 may include optocoupler output 2806. Optocoupler output 2806 may receive the signal from optocoupler input 2720. LLC circuitry 2800 may include IC 2804. IC 2804 may include a stored reference voltage. Optocoupler output 2806 may transmit a voltage corresponding to the signal to IC 2804 via the BURST pin. IC 2804 may compare the voltage to the reference voltage. In response to the voltage being less than the reference voltage, IC 2804 may cause LLC circuitry 2800 to be in idle state. When LLC circuitry 2800 is in an idle state, power may no longer be transmitted via terminal 2702. When LLC circuitry 2800 is in an idle state, the power may be cut off. When the power is cut off, power may not be transmitted via terminal 2702.

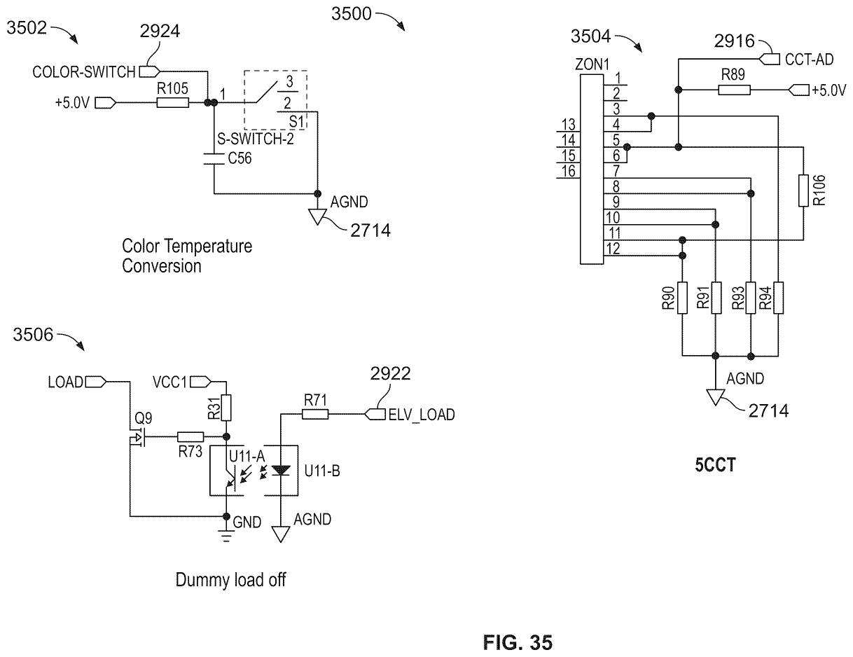

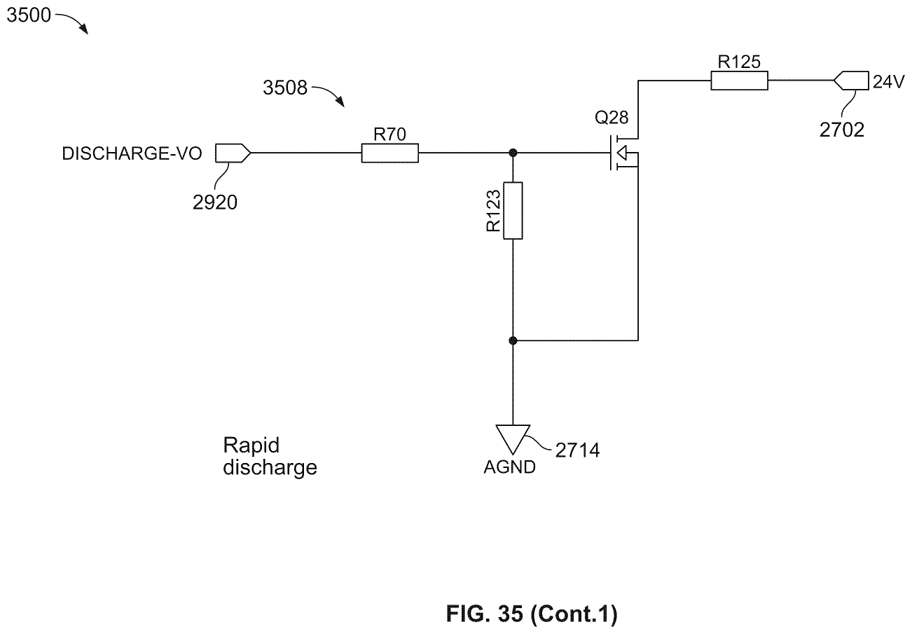

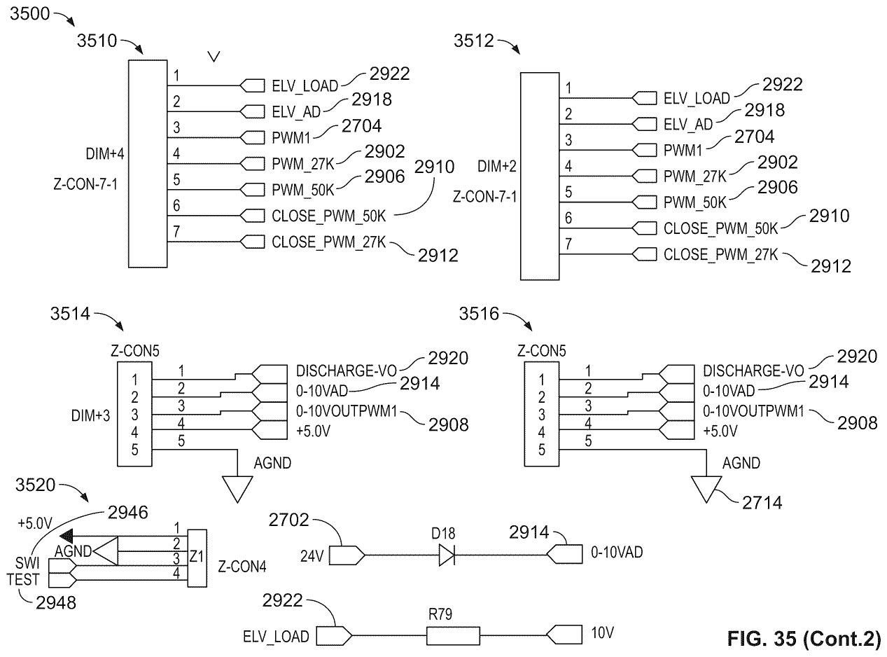

FIG. 29 shows illustrative microcontroller 2900. Microcontroller 2900 may receive a CCT selection via terminal 2916. The CCT selection may be selected by a user. The CCT selection may be received from switch 3504 (shown in FIG. 35). Switch 3504 may receive the selected CCT from a CCT selector. When different CCTs are selected, a voltage being transmitted through terminal 2916 may change. Microcontroller 2900 may detect the change in voltage. In response to detecting the change in voltage, microcontroller may determine a corresponding color mixing ratio. Microcontroller 2900 may output the determined color mixing ratio via signals 2906 (PWM_50K) and 2902 (PWM_27K). Table 5 shows illustrative CCT input, corresponding voltages and associated color mixing ratios.

TABLE 5
Illustrative CCT input, corresponding voltages
and associated color mixing ratios.

| Actual CCT | CCT_AD Voltage | PWM_27K Ratio | PWM_50K ratio |
|---|---|---|---|
| 5000K | 0.45 V | 1% | 99% |
| 4000K | 1.6 V | 35% | 65% |
| 3500K | 2.5 V | 60% | 40% |
| 3000K | 3.3 V | 80% | 20% |
| 2700K | 5.0 V | 99% | 1% |

When 5V is transmitted through terminal 2916, microcontroller 2900 may transmit a PWM of 1 (ON) through signal 2910 (CLOSE_PWM_50K). Microcontroller 2900 may transmit a PWM of 1 (ON) through signal 2910 (CLOSE_PWM_50K) to color temperature adjustment module 3000. Transmitting a PWM of 1 (ON) through signal 2910 (CLOSE_PWM_50K) may enable LEDs coupled to color temperature adjustment module 3000 to emit a light having a CCT of 2700 K.

When 0.45V is transmitted through terminal 2916, microcontroller 2900 may transmit a PWM of 1 (ON) through signal 2912 (CLOSE_PWM_27K). Microcontroller 2900 may transmit a PWM of 1 (ON) through signal 2912 (CLOSE_PWM_27K) to color temperature adjustment module 3000. Transmitting a PWM of 1 (ON) through signal 2912 (CLOSE_PWM_27K) may enable LEDs coupled to color temperature adjustment module 3000 to emit a light having a CCT of 5000 K.

Microcontroller 2900 may provide a dimming level to 24V, output voltage/current control circuitry 2700 through terminal 2704 (PWM1). The dimming level may be determined based on dimming inputs received through terminal 2918 (ELV_AD) or terminal 2914 (0-10VAD). The dimming inputs may be transmitted from either TRIAC/ELV circuitry 3100 or 0-10V circuitry 3200. TRIAC/ELV circuitry 3100 and 0-10V circuitry 3200 may be connected to dimming controllers. TRIAC/ELV circuitry 3100 and 0-10V circuitry 3200 may receive user selected dimming selections.

Microcontroller 2900 may maintain electronic communication with TRIAC/ELV circuitry 3100 via terminal 2922 (ELV_LOAD) and with 0-10V circuitry 3200 via terminal 2908 (0-10V-OUTPWM1).

Microcontroller 2900 may include terminal 2948 (TEST) and terminal 2946 (SWI). Terminal 2948 (TEST) may be used for factory diagnostics or special test modes. Terminal 2946 (SWI) may provide a single-wire interface for programming and debugging.

Microcontroller 2900 may include terminal 2924 (color-switch). Microcontroller 2924 may be in electronic communication with switch 3502 (shown in FIG. 35) via terminal 2924 (color-switch). Switch 3502 may be used to select/change the CCT. Microcontroller 2900 may include terminal 2920 (DISCHARGE-VO).

Microcontroller 2900 may be in electronic communication with switch 3508 (shown in FIG. 35) via terminal 2920 (DISCHARGE-VO). Terminal 2920 (DISCHARGE-VO) may be used for a rapid discharge.

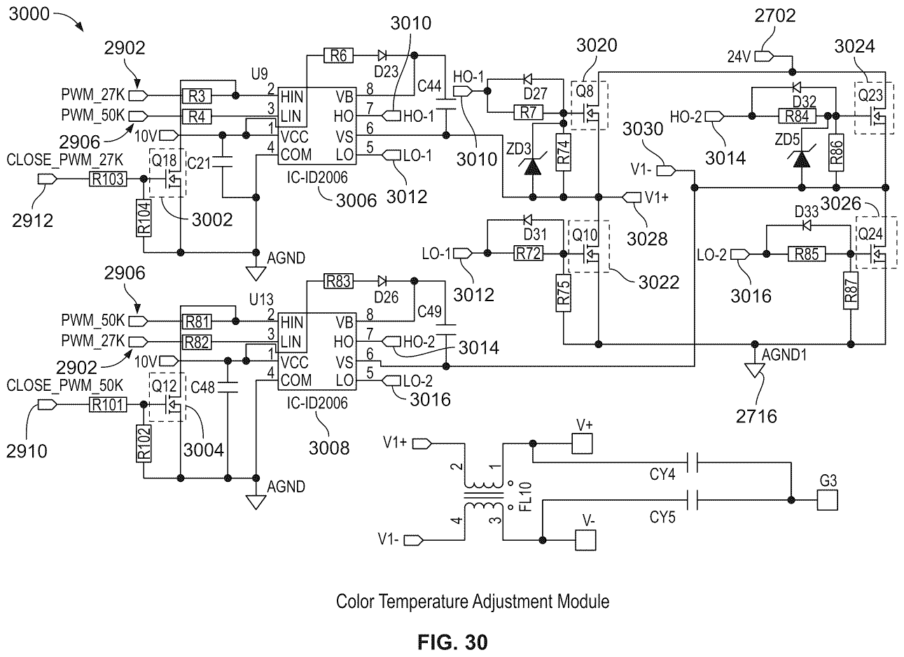

FIG. 30 shows illustrative color temperature adjustment module 3000. Color temperature adjustment module 3000 may include an H-bridge. The H-bridge may include MOSFET 3020 (Q8). The H-bridge may include MOSFET 3024 (Q23). The H-bridge may include MOSFET 3022 (Q10). The H-bridge may include MOSFET 3026 (Q24). Voltage transmitted through terminal 2702 (24V), relative to ground 2716, may be applied to the H-bridge. Voltage transmitted through terminal 2702 (24V) may power first CCT LEDs (2700K) and second CCT LEDs (5000K). MOSFETs 3020 (Q8), 3024 (Q23), 3022 (Q10) and 3026 (Q24) may direct lighting power from voltage transmitted through terminal 2702 (24V).

In a first state, MOSFETs 3020 (Q8) and 3026 (Q24) may be open (conducting) and MOSFETs 3022 (Q10) and 3024 (Q23) may be closed (non-conducting). In the first state, output pole 3028 (V1+) may be HIGH and output pole 3030 (V1−) may be LOW. Current may flow through the first CCT LEDs, which are aligned to conduct from output pole 3028 (V1+) to output pole 3030 (V1−) when output pole 3028 is HIGH, and not through the second CCT LEDs, which are aligned with polarity opposite the first CCT LEDs.

In a second state, MOSFETs 3022 (Q10) and 3024 (Q23) may be open and MOSFETs 3020 (Q8) and 3026 (Q24) may be closed. In the second state, output pole 3030 (V1−) may be HIGH and output pole 3028 (V1+) may be LOW. Current may flow through the second CCT LEDs, which are aligned to conduct from output pole 3030 (V1−) to output pole 3028 (V1+) when output pole 3030 is HIGH, and not through the first CCT LEDs, which are aligned with polarity opposite the second CCT LEDs.

In a third state, the H-bridge may alternate between the first and second states. The alternation may have a duty cycle. The alternation may be based on fractions of the duty cycle.

Color temperature adjustment module 3000 may include IC 3006 (U9). IC 3006 (U9) may output PWM voltages 3010 (H01) and 3012 (L01), which may control, respectively MOSFETs 3020 (Q8) and 3022 (Q10). IC 3006 (U9) may receive signal 2902 (PWM_27K) and signal 2906 (PWM_50K). IC 3006 (U9) may receive signal 2902 (PWM_27K) at pin HIN. IC 3006 (U9) may receive signal 2906 (PWM_50K) at pin LIN.

Color temperature adjustment module 3000 may include IC 3004 (U13). IC 3004 (U13) may output PWM voltages 3014 (H02) and 3016 (L02), which may control, respectively MOSFETs 3024 (Q23) and 3026 (Q24). IC 3004 (U13) may receive signal 2906 (PWM_50K) and signal 2902 (PWM_27K). IC 3004 (U13) may receive signal 2906 (PWM_50K) at pin HIN. IC 3004 (U13) may receive signal 2902 (PWM_27K) at pin LIN.

The sum of signals 2906 (PWM_50K) and 2902 (PWM_27K) may correspond to a dimming level received from a user. The difference of signals 2906 (PWM_50K) and 2902 (PWM_27K) may correspond to a difference in intensity of light emission from first CCT LEDs and second CCT LEDs. The difference of signals 2906 (PWM_50K) and 2902 (PWM_27K) may correspond to a difference in intensity of light emission from first CCT LEDs and second CCT LEDs. The difference may be based on an OFF condition in one of the first CCT LEDs and second CCT LEDs. The difference may be based on a difference of ON conditions between one of the first CCT LEDs and second CCT LEDs. Current flow may be apportioned between LED the first CCT LEDs and second CCT LEDs.

Input of signals 2902 (PWM_27K) and 2906 (PWM_50K) to IC 3006 (U9) and input of signals 2906 (PWM_50K) and 2902 (PWM_27K) to IC 3008 (U13) may enable individual control of the H-bridge.

Color temperature adjustment module 3000 may include MOSFET 3002. In response to receiving signal 2912 (CLOSE_PWM_27K), MOSFET 3002 may turn off MOSFETs 3020 (Q8) and 3026 (Q24). Turning off MOSFETs 3020 (Q8) and 3026 (Q24) may prevent current from flowing to the first CCT LEDs. When MOSFETs 3020 (Q8) and 3026 (Q24) are turned off and MOSFETs 3022 (Q10) and 3024 (Q23) are open, current may only flow to the second CCT LEDs. Turning off MOSFETs 3020 (Q8) and 3026 (Q24) may prevent leakage current from flowing to the first CCT LEDs.

Color temperature adjustment module 3000 may include MOSFET 3002. In response to receiving signal 2910 (CLOSE_PWM_50K), MOSFET 3002 may turn off MOSFETs 3022 (Q10) and 3024 (Q23). Turning off MOSFETs 3022 (Q10) and 3024 (Q23) may prevent current from flowing to the second CCT LEDs. When MOSFETs 3022 (Q10) and 3024 (Q23) are turned off and MOSFETs 3020 (Q8) and 3026 (Q24) are open, current may only flow to the first CCT LEDs. Turning off MOSFETs 3022 (Q10) and 3024 (Q23) may prevent leakage current from flowing to the second CCT LEDs.

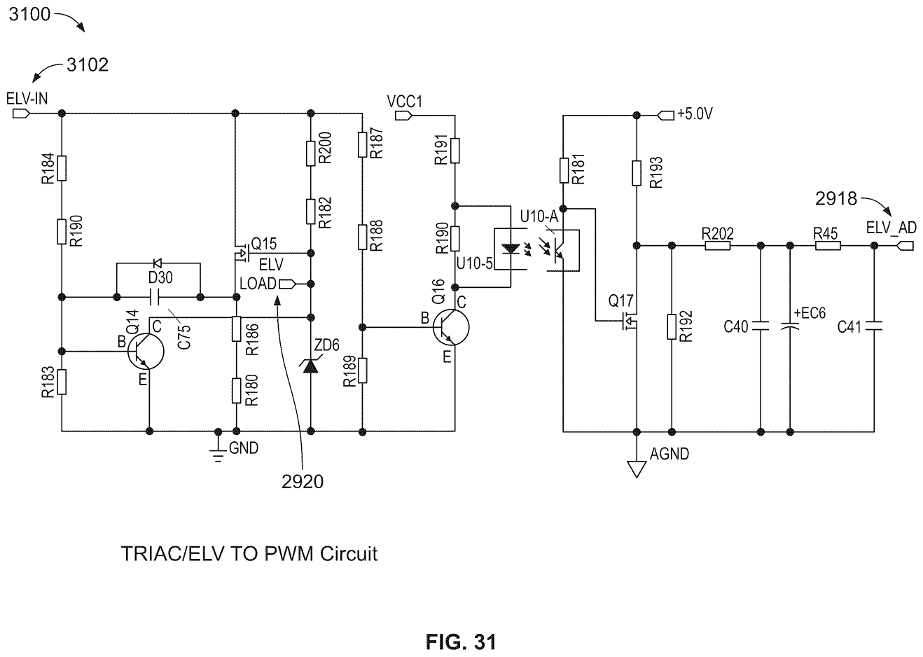

FIG. 31 shows illustrative TRIAC/ELV circuitry 3100. TIRAC/ELV circuitry 3100 may receive AC voltage through terminal 3102 (ELV-IN). TRIAC/ELV circuitry 3100 may receive AC voltage from EMI circuitry 3300. TRIAC/ELV circuitry 3100 may alternate cutting and conducting of the current along the AC waveform to produce a dimming level. TRIAC/ELV circuitry 3100 may translate the dimming level into a microcontroller readable signal. TRIAC/ELV circuitry 3100 may transmit the microcontroller readable dimming signal to microcontroller 2900. TRIAC/ELV circuitry 3100 may transmit the microcontroller readable dimming signal to microcontroller 2900 via terminal 2918 (ELV_AD). TRIAC/ELV circuitry 3100 may maintain electronic communication with microcontroller 2900 via terminal 2920 (ELV_LOAD).

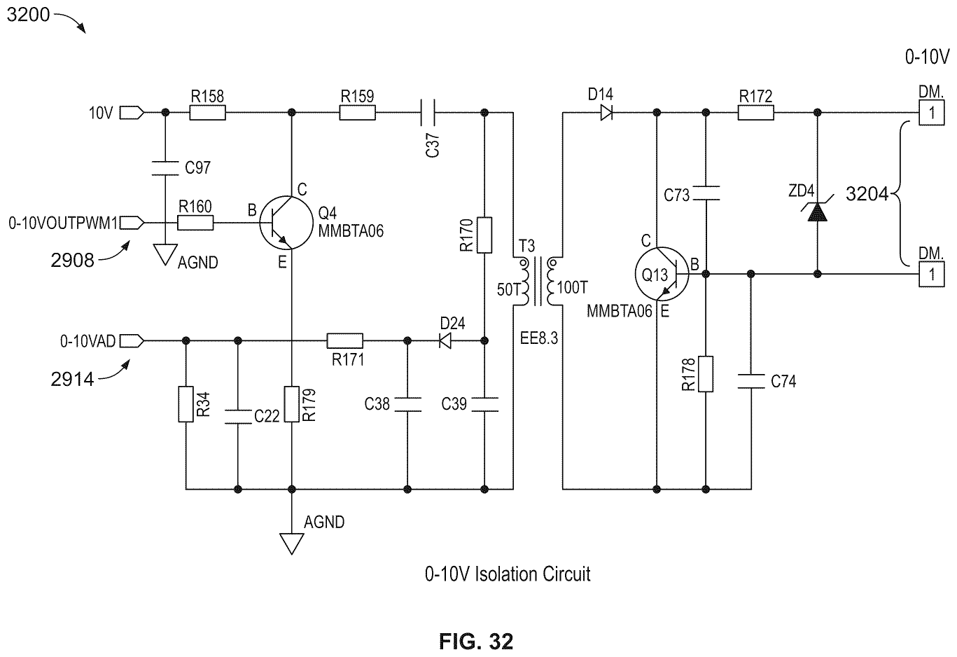

FIG. 32 shows illustrative 0-10V circuitry 3200. 0-10V circuitry 3200 may receive voltage through a 10V terminal. 0-10V circuitry 3200 may receive signals corresponding to a user selected 0-10V dimming level from a 0-10V controller. 0-10V circuitry 3200 may receive signals corresponding to the user selected 0-10V dimming level from the 0-10V controller via input 3204. 0-10V circuitry 3200 may transmit the user selected 0-10V dimming level to microcontroller 2900. 0-10V circuitry 3200 may transmit the user selected 0-10V dimming level to microcontroller 2900 through terminal 2914 (0-10_VAD). 0-10V circuitry 3200 may maintain electronic communication with microcontroller 2900 via terminal 2908 (0-10VOUTPWM1).

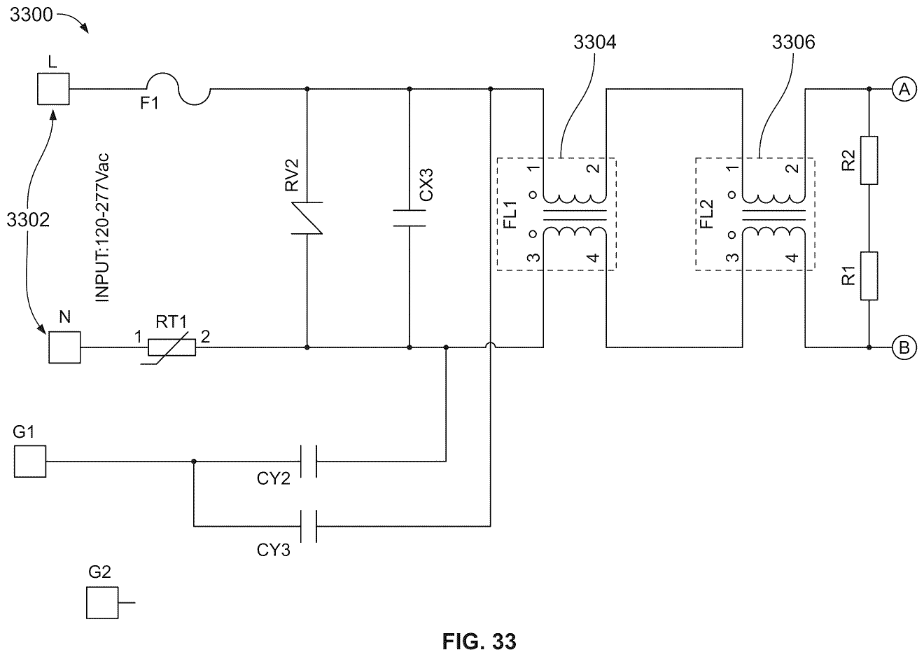

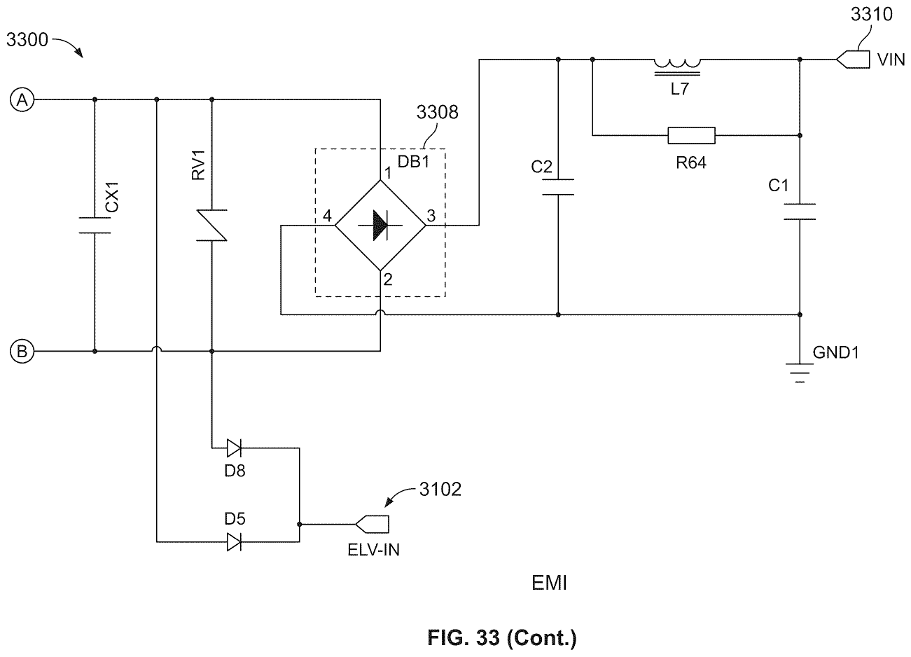

FIG. 33 shows illustrative electromagnetic interference (“EMI”) circuitry 3300. EMI circuitry 3300 may include input voltage terminals 3302. Input voltage terminals 3302 may receive line voltage. The line voltage may be 120-277 VAC. The line voltage may include noise. EMI circuitry 3300 may include or common mode inductors 3304 (FL1) and 3306 (FL2). Common mode inductors 3304 and 3306 may be used to remove and/or suppress noise and other EMI from the line voltage.

EMI circuitry 3300 may contain rectifier bridge 3308 (DB1). Rectifier bridge 3308 may rectify the AC line voltage. The rectified voltage may be smoothed into a DC waveform using a capacitor. EMI circuitry 3300 may output a DC voltage. EMI circuitry 3300 may output a DC voltage through terminal 3310. EMI circuitry 3300 may convert line voltage of 120-277 VAC to 120 VDC. EMI circuitry 3300 may output 120 VDC through terminal 3310.

EMI circuitry 3300 may include terminal 3102 (ELV-IN). Terminal 3102 (ELV-IN) may connect to TRIAC/ELV circuitry 3100. Terminal 3102 (ELV-IN) may transmit an input voltage from EMI circuitry 3300 to TRIAC/ELV circuitry 3100. The input voltage may be transmitted before it is converted to a DC voltage. The input voltage transmitted may be AC voltage. The voltage may be transmitted to TRIAC/ELV circuitry 3100 to provide a signal for phase angle dimming to microcontroller 2900. The AC voltage may be used to determine a dimming level from a phase cut dimmer.

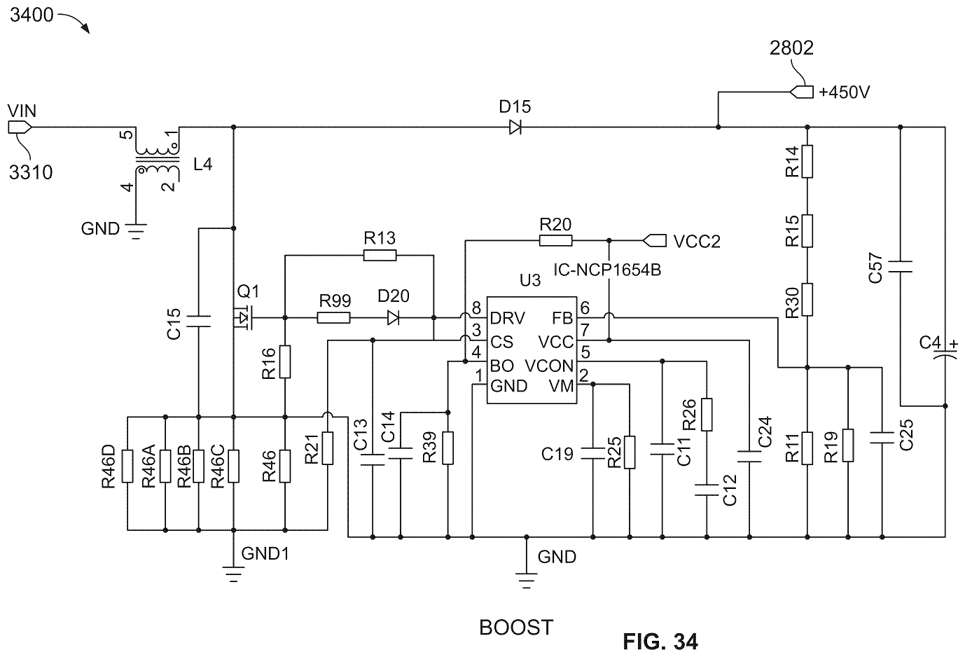

FIG. 34 shows illustrative boost circuitry 3400. Boost circuitry 3400 may boost voltage received through terminal 3310. Voltage received through terminal 3310 may be 120 VDC. Boost circuitry 3400 may boost the voltage from 120 VDC to 450 VDC. Boost circuitry 3400 may transmit the boosted voltage through terminal 2802.

FIG. 35 shows illustrative switches/junctions 3500. Switches/junctions 3500 may include switches 3502, 3504, 3506, 3508, 3510, 3512, 3514, 3516 and 3520. Switches 3502, 3504, 3506, 3508, 3510, 3512, 3514, 3516 and 3520 may be in electronic communication with microcontroller 2900 through various different terminals.

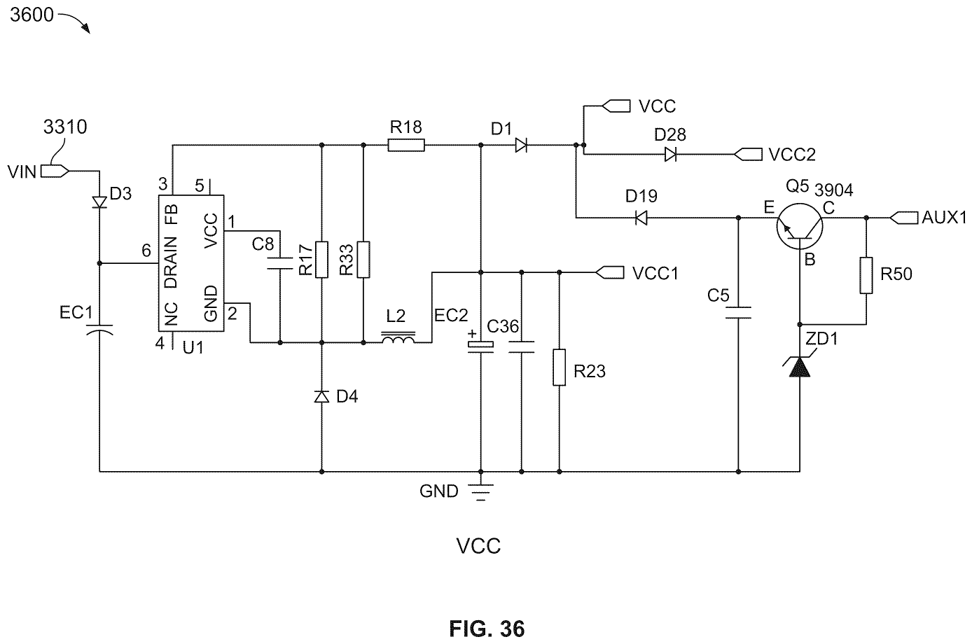

FIG. 36 shows illustrative VCC circuitry 3600. VCC circuitry 3600 may receive a DC voltage through terminal 3310. VCC circuitry 3600 may output a VCC voltage. VCC circuitry 3600 may output the VCC voltage through VCC, VCC1, VCC2 and AUX1 terminals.

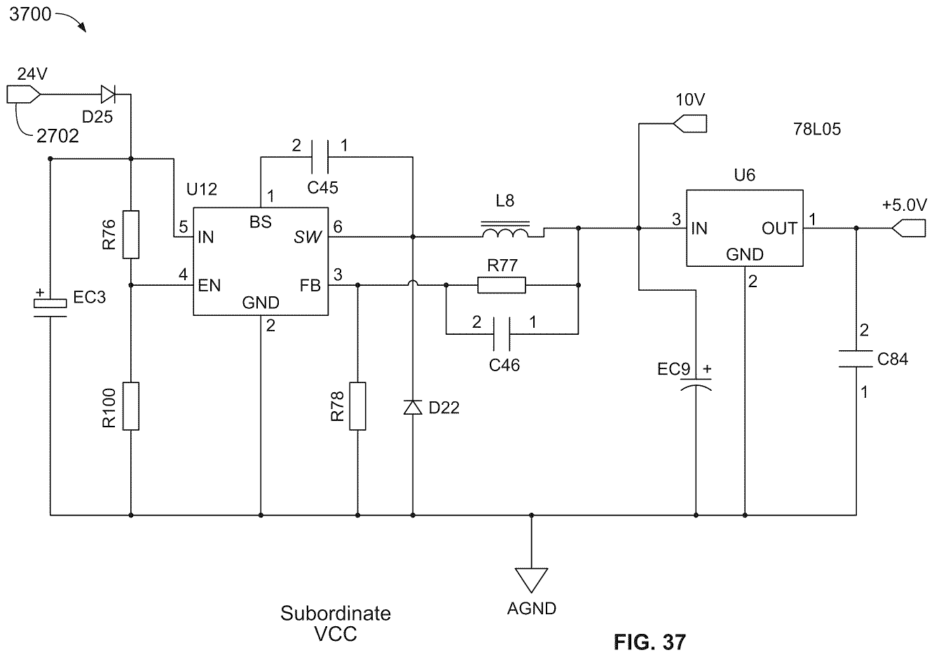

FIG. 37 shows illustrative secondary VCC circuitry 3700. Secondary VCC 3700 may receive voltage through terminal 2702. Secondary VCC circuitry 3700 may output secondary VCC voltage. Secondary VCC circuitry 3700 may output secondary VCC voltage through a 5.0V terminal.

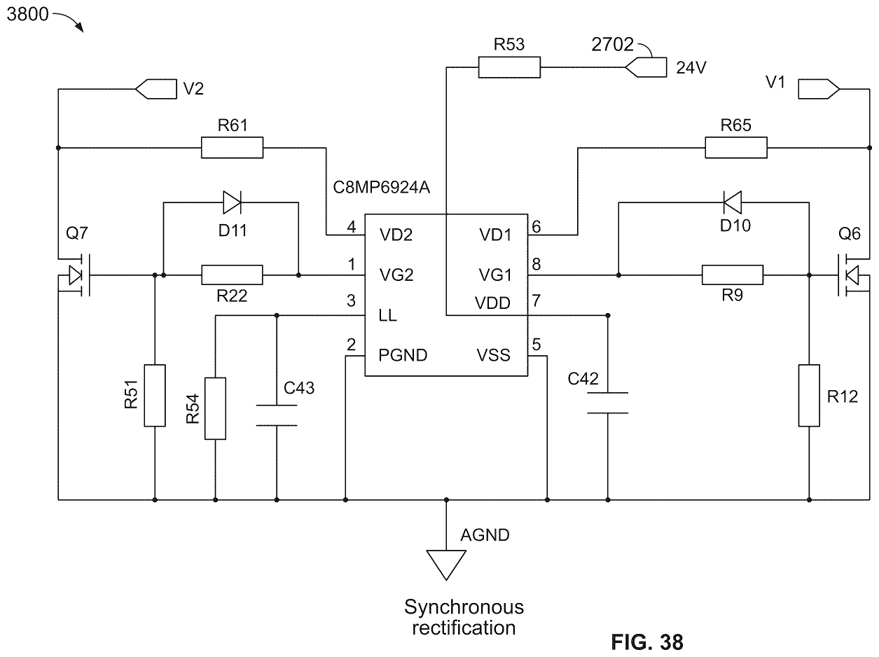

FIG. 38 shows illustrative synchronous rectification circuitry 3800. Synchronous rectification circuitry 3800 may be in electronic communication with LLC circuitry 2800 via terminals 2702, V1 and V2.

Table 6 lists illustrative parts that may be associated with one or more circuits described in FIGS. 27-38.

TABLE 6
Illustrative parts that may be associated with
one or more circuits described in FIGS. 27-38.

| Illustrative Part | Tag |
|---|---|
| RESISTOR 0.1 W 10 R 0603 | R9, R22, R7, R72, R84, R85 |
| 1/10 W CHIP RESISTOR, 100 R ± 1%(0603) | R24, R98, R101, R103 |
| 0.1 W CHIP RESISTOR 430 R 1 0603 | R5 |
| RESISTOR 0.1 W CHIP 2K 0603 | R113, R27, R191, R202 |
| Resistor 1/10 W-2.2K-1-0603 | R78 |
| 1/10 W CHIP RESISTOR, 3K ± 1%(0603) | R193 |
| RESISTOR 0.1 W 1.5K 0603 | R69, R181 |
| 1/10 W CHIP RESISTOR, 3K ± 1%(0603) | R44 |
| 1/10 W_SMD RESISTOR_4.7K ± 1%(0603) | R21 |
| Resistor 1/10 W-5.6K-1-0603 | R33 |
| 1/10 W CHIP RESISTOR, 1K ± 1%(0603) | R58, R35, R3, R4, R81, |
| | R82, R190, R48, R47 |
| Resistor 1/10 W-10K-1-0603 | R26, R67, R59, R32, |
| | R36, R102, R104, R45 |
| 1/10 W CHIP RESISTOR 9.1K ± 1% 0603 | R41 |
| Resistor 1/10 W-10K-1-0603 | R43, R62 |
| RESISTOR 0.1 W CHIP 5.1K 0603 | R56 |
| 0.1 W CHIP RESISTOR 6.8K 1 0603 | R42 |
| 1/10 W CHIP RESISTOR, 15K ± 1%(0603) | R100 |
| RESISTOR 0.1 W CHIP 20K 0603 | R88, R63 |
| 1/10 W CHIP RESISTOR 28K ± 1%(0603) | R19, R77, R92 |
| 1/10 W CHIP RESISTOR, 39K ± 1%(0603) | R18 |
| RESISTOR 0.1 W 47K 0603 | R97 |
| Resistor 1/10 W-51K-5-0603 | R17, R54 |
| Resistor 1/10 W-68K-1-0603 | R68 |
| 1/10 W CHIP RESISTOR 30K ± 1%(0603) | R39, R192 |
| Resistor 1/10 W-100K-5-0603 | R25, R76 |
| 1/10 W CHIP RESISTOR, 200K ± 1%(0603) | R20 |
| 0.1 W CHIP RESISTOR 270K 1 0603 | R11 |
| RESISTOR 0.1 W CHIP RESISTOR 330K 0603 | R80 |
| 0.1 W CHIP RESISTOR 820K 5 0603 | R57 |
| ⅛ W CHIP RESISTOR, 10 R ± 1%(0805) | R83, R6, R70 |
| 0.125 W CHIP RESISTOR 75 R 1 0805 | R66 |
| ⅛ W CHIP RESISTOR, 3K ± 1%(0805) | R60 |
| ⅛ W CHIP RESISTOR, 20 R ± 1%(0805) | R99 |
| 0.125 W SMD RES 47 R 0805 | R28, R49 |
| ⅛ W CHIP RESISTOR 160 R ± 1%(0805) | R13 |
| ⅛ W CHIP RESISTOR, 1K ± 1%(0805) | R61, R65 |
| Resistor ⅛ W-5.1K-1-0805 | R206 |
| ⅛ W CHIP RESISTOR, 10K ± 1%(0805) | R29, R50, R12, R51, R16, |
| | R74, R75, R86, R87, R123 |
| RESISTOR 0.125 W 22K 0805 | R189 |
| Resistor ¼ W-470R-1-1206 | R53 |
| Resistor ¼ W-1R-1-1206 | R46, R46B, R46C, R46D, R46A |
| Resistor ¼ W-100K-5-1206 | ZD2 |
| Resistor ¼ W-220K-5-1206 | R187, R188 |
| Resistor ¼ W-1M-5-1206 | R1, R2 |
| SMD RESISTANCE 0.25 W 1M5 1 1206 | R14, R15, R30 |
| Resistor ¼ W-3M-5-1206 | R37, R38, R40 |
| Resistor ¼ W-5.1R-1-1206 | R55 |
| 1 W SMT RESISTOR 0.02 R 1 2010 | R52 |
| 0.75 W CHIP RESISTOR 1.0K 5 2010 | R64 |
| NPO SMD CAP 100 pF 50 V 5 125 C 0603 | C46, C58 |
| NPO SMD CAP 470 PF 50 V 5 125 °C 0603 | C33 |
| CHIP CAP X7R 1 nF 50 V 10 125 0603 | C19, C23, C3 |
| CHIP CAP X7R 10 nF 50 V 10 125 0603 | C25, C34, C43 |
| CAP X7R SMD 22 nF 50 V 125 C 0603 | C18 |
| CHIP CAP X7R 100 nF 50 V 10 125 0603 | C29, C50, C51, C17, C44, |
| | C49, C78, C40, C41 |
| CHIP CAP X7R 1 uF 50 V 10 125 0603 | C11, C12, C24, C8, C36, |
| | C30, C31, C45, C53 |
| CHIP CAP X7R 1 uF 50 V 10 125 0805 | C5, C21, C84, C48 |
| CHIP CAP X7R 2.2 uF 25 V 10 125 0805 | C35, C42 |
| CHIP CAP X7R 470 nF 50 V 10 125 0603 | C14, C32 |
| CHIP CAP X7R 100 nF 50 V 10 125 0805 | C9 |
| NPO SMD CAP 10 PF 1 KV 5 125 °C 1206 | C27, C27A |
| CHIP CAP X7R 100 pF 1 KV 10 125 1206 | C15 |
| CHIP CAP NPO 150 pF 1 KV 10 125 1206 | C28 |
| CAP X7R 10 nF 1 KV 125 C 1206 | C57 |
| DIODE 15 V 0.5 W SOD 123 | ZD3, ZD5 |
| SCHOTTKY DIODE 0.35 A 40 V SD103AW | D7 |
| SOD123 | |
| DIODE 1 A 1000 V SOD 123 | D3, D25, D5, D8 |
| DIODE ES1JW 1 A 600 V SOD 123FL | D4 |
| DIODE IN4148W 0.15 A 75 V SOD-123 | D20, D13, D12, D17, |
| | D16, D26, D23 |
| DIODE SOD1F6 1 A 600 V SOD 123FL | D9 |
| DIODE B5819WS 1 A 40 V SOD 323 | D1, D28, D19, D10, D11, |
| | D27, D31, D32, D33 |
| DIODE 13 V 0.5 W SOD 123 | ZD1 |
| TRANSISTORS 2SD1760U SOT 89 60 V | Q5 |
| TRANSISTER MMBTA06 1GM SOT 23 | Q16 |
| NEW SMTNMOS 13 A 700 V CRJD360N70G2 | Q1 |
| TO252 | |
| SMDN MOSFET 8NM65L TN3 R 8 A 650 V | Q2, Q3 |
| TO252 | |
| MOS SMD N 3 A 60 V UT3N06GAB3R SOT89 | Q28 |
| IC BP8519C SOT23-5 | U1 |
| PHOTOCOUPLER BL817S 4pin | U2, U10 |
| SMT IC ON NCP1654BD65R2G SO8 ROHS | U3 |
| SMT IC MPS HR1001BGS SOIC16 ROHS | U7 |
| SMT IC MPS MP6924A SOP8 ROHS | U8 |
| IC TL431 SOT-23-1 | U26 |
| IC BL78L05 SOT-89 | U6 |
| IC LM258 SO-8 | U4, U5 |
| IC ID2006 SOIC8 RoHS | U9, U13 |
| CAP SMD Y1 2.2 nF 400 V 20 | CY1 |
| SMD NMOS 60 A 100 V PW120N10GS TO 252 2L | Q6, Q7 |
| MOS SMT N 55 A 60 V CS55N06A4 TO252 | Q8, Q10, Q23, Q24 |
| DIODE 2 A 60 V DSK26 SOD 123F | D22 |
| SMD IC H6601 SOT23 6 RoHS | U12 |
| MOSFET 2N7002 60 V 250 mA SOT 23 | Q11, Q12, Q18, Q17 |
| MOSFET UTC 4N65KG TN3 R TO 252 | Q15 |
| Resistor ¼ W-220K-5-1206 | R184, R199, R182, R200 |
| Resistor ¼ W-10R-5-1206 | R185, R186 |
| DIODE 15 V 0.5 W SOD 123 | ZD6 |
| DIODE BAV21W 0.2 A 200 V SOD 123 | D30 |
| CHIP CAP 47 pF 50 V 125 °C 0805 | C75 |
| SMD TRANSISTOR MMBTA44 VCEO 400 V | Q14 |
| TO236 | |
| 0.1 W SMD RESISTOR 1.8K 0603 | R183 |
| MOSFET 2N7002 60 V 250 mA SOT 23 | Q9 |
| ⅛ W CHIP RESISTOR, 3K ± 1%(0805) | R31 |
| RESISTOR 0.1 W 10 R 0603 | R73 |
| PHOTOCOUPLER BL817S 4pin | U11 |
| 1/10 W CHIP RESISTOR, 1K ± 1%(0603) | R71, R180, R170, R172 |
| CHIP CAP X7R 100 nF 50 V 10 125 0603 | C97, C22, C38, C73 |
| 1/10 W CHIP RESISTOR, 3K ± 1%(0603) | R168 |
| CHIP CAP X7R 1 uF 50 V 10 125 0805 | C37 |
| ⅛ W CHIP RESISTOR, 100Ω ± 1%(0805) | R169, R179 |
| TRANSISTER MMBTA06 1GM SOT 23 | Q4, Q13 |
| RESISTOR 0.1 W 62K 0603 | R34 |
| 1/10 W CHIP RESISTOR, 15K ± 1%(0603) | R171 |
| NPO SMD CAP 100 pF 50 V 5 125 C 0603 | C39 |
| DIODE IN4148W 0.15 A 75 V SOD-123 | D24, D14 |
| 1/10 W SMD RESISTOR_4.7K ± 1%(0603) | R178 |
| CHIP CAP X7R 470 nF 50 V 10 125 0603 | C74 |
| DIODE 12 V 0.5 W SOD 123 | ZD4 |
| DOUBLE PCB FR4 170 × 53.5 × 1.6 mm 1 × 3 RoHS | C16 |
| X7R SMT CAP 220 n 10 50 V 125 °C 0603 | |
| DOUBLE PCB FR4 26 × 37.1 × 1.0 mm 4 × 6 RoHS | U15 |
| IC SMD ME32S003AF6P7 TAPE REEL ROHS | |
| 1/10 W CHIP RESISTOR, 1K ± 1%(0603) | R90 |
| 1/10 W_SMD RESISTOR 4.7K ± 1%(0603) | R91 |
| CHIP CAP X7R 100 nF 50 V 10 125 0603 | C26, C55, C20, C54, C56 |
| Resistor 1/10 W-10K-5-0603 | R93, R8, R89, R105 |
| RESISTOR 0.1 W CHIP 20K 0603 | R94 |
| SWITCH DP SS-25D01G5 | ZON1 |
| DP SWITCH × 7 mm | S1 |
| PH 2.54 2 × H2.54 × 7PIN L22 MM SINGLE TERMINA | DIM + 4 |
| TERMINAL PH 2.54 2 × H2.54 × 5PIN SINGLE | DIM + 3 |
| 24 V 5CCT2W TAPELIGHT ME32S003AF6P7 | Z1 |
| REV. A | |
| FUSE 3.15 A 300 V 93213153 8.5 × 8 × 4.5 | F1 |
| DIP NTC RESISTANCE 5 D 9 5 R 20 | RT1 |
| Resistor 10 mm-510 V-10-7.5P-T/R-KJH | RV1, RV2 |
| FILM CAP X2 100 nF 305 V P10 T5 | CX1, C2 |
| CAPACITOR X2 100 nF 305 V P7.5 T6 | CX3 |
| X2 CAP 0.22 uF 310 V 10 P10 L5 | C1 |
| INDUCTOR 10 × 6 × 4 1 mH 30 | FL1 |
| CHOKE UU10.5 70 70 22 mH MIN | FL2 |
| INDUCTOR T13 × 7 × 5 18UH | FL10 |
| DIP BRIDGE 4 A 1000 V GBP410 GBP | BD1 |
| SENDUST INDUCTOR 430UH MIN KS065125 | L7 |
| CAP Y2 1 nF 300 V P7.5 | CY2, CY3 |
| ELECTROLYTI CAP 1 uF 500 V 105 6.3 × 11 | EC1 |
| INDUCTOR CKL0510 2.8 mH | L2 |
| SUPER FAST 10 A 600 V SF1008F ITO220AC | D15 |
| ELECTROLYTI CAP 22 uF 50 V 5 × 11 7000 H | EC2, EC4 |
| ELECTROLYTI CAP 10 uF 50 V 5 × 11 | EC3, EC9, EC6 |
| ECAP FT 33 UF 500 V 20 105 °C 6000 H 16 × 25 | C4 |
| INDUCTOR DR04X06 22 uH 10 | L8 |
| 2WS DIP RESISTOR 100 R | R125 |
| MMKP82 27 NF 1000 V 5 P 15 L 3.5 | C7 |
| ELECTROLYTI CAP 1000 uF 35 V 105 C | EC5 |
| 10 × 20 mm | |
| 0.6 mm JUMP LINE LENGTH 12 mm | J1, J2 |
| 0.6 mm JUMP LINE LENGTH 24.5 mm | J3, J4 |
| TRANSFORMER PQ2620 0.1 × 30 × 65.5 L | L4 |
| 550UH | |
| TRANSFORMER ER28 54 6 6 L 1.1MH | T1 |
| 18# WT TEFLON L 220 ALL 13/DIP 3 | N |
| 18# BK TEFLON L 220 ALL 13/DIP 3 | L |
| 16# RD TEFLON L 150 DIP 10/3 | V+ |
| 16# BK TEFLON L 150 DIP 10/3 | V− |
| Magnetic beads RH3.5 × 3 × 1.5 | CY2, CY3, D15 Pin (Y |
| | capacitor only has one pin.) |
| TRANSFORMER EE8.3 100-50 26MH 30PP | T3 |
| 22# PR TEFLON L 320 DIP 10/3 | DIM+ |
| 22# PK TEFLON L 320 DIP 10/3 | DIM− |
| Other illustrative parts | |

Embodiments may include features that are neither shown nor described in connection with the illustrative apparatus. Features of illustrative apparatus may be combined. For example, an illustrative embodiment may include features shown in connection with another illustrative embodiment. It is to be understood that structural, functional and procedural modifications or omissions may be made without departing from the scope and spirit of the present invention.

As will be appreciated by one of skill in the art, apparatus and methods shown or described herein may be embodied in whole or in part as a method, a data processing system, or a computer program product. Accordingly, such apparatus may take the form of, and such methods may be performed by, an entirely hardware embodiment, an entirely software embodiment or an embodiment combining software, hardware and any other suitable approach or apparatus.

Functions of electrical circuits, or parts thereof, disclosed herein may be incorporated into or combined with other electrical circuits, or parts thereof, disclosed herein, or with other suitable electrical circuits.

All ranges and parameters disclosed herein shall be understood to encompass any and all subranges subsumed therein, every number between the endpoints, and the endpoints. For example, a stated range of “1 to 10” should be considered to include any and all subranges between (and inclusive of) the minimum value of 1 and the maximum value of 10; that is, all subranges beginning with a minimum value of 1 or more (e.g. 1 to 6.1), and ending with a maximum value of 10 or less (e.g., 2.3 to 9.4, 3 to 8, 4 to 7), and finally to each number 1, 2, 3, 4, 5, 6, 7, 8, 9, and 10 contained within the range.

Thus, apparatus, methods and systems for lighting control have been provided. Persons skilled in the art will appreciate that the present invention may be practiced by other than the described embodiments, which are presented for purposes of illustration rather than of limitation.

1. Apparatus for providing light having a color correlated temperature (“CCT”) selectable from a range of CCTs, the range of CCTs including a highest CCT, a lowest CCT and a plurality of CCTs between the highest CCT and the lowest CCT, the apparatus comprising:
power circuitry configured to provide power to a plurality of light-emitting diodes (LEDs) including a first array of LEDs having a first polarity and the highest CCT coupled in parallel with a second array of LEDs having a second polarity and the lowest CCT; and
control circuitry that:
is configured to:
receive an input dimming level corresponding to a dimming selection selected by a user;
provide a shifted dimming level based on the input dimming level; and
detect:
a voltage condition corresponding to the shifted dimming level; and
a current condition corresponding to the plurality of LEDs; and
includes a switch that is configured to transmit a power control signal that is configured to:
modulate the power based on the voltage condition; and
modulate the power based on the current condition.

2. The apparatus of claim 1 wherein the control circuitry is configured to provide a variable driving voltage to the plurality of LEDs.

3. The apparatus of claim 2 wherein, relative to the variable driving voltage, the first polarity is opposite the second polarity.

4. The apparatus of claim 3 wherein the voltage condition is defined by a comparison between:
a shifted dimming voltage that corresponds to the shifted dimming level; and
a threshold voltage.

5. The apparatus of claim 4 wherein:
the switch includes a transmitter configured to transmit the power control signal when the shifted dimming voltage is less than the threshold voltage; and
the power circuitry includes a receiver configured to receive the power control signal;
wherein the power control signal is configured to prevent the power circuitry from providing the power to the plurality of LEDs.

6. The apparatus of claim 5 wherein the control circuitry further includes a voltage source that is configured to counteract a reduction of the variable driving voltage to the plurality of LEDs in response to a reduction of the power.

7. The apparatus of claim 6 wherein the voltage source is an electrolytic capacitor.

8. The apparatus of claim 6 wherein the voltage source is a capacitor.

9. The apparatus of claim 6 wherein:
the threshold voltage is a first threshold voltage; and
the current condition is defined by a comparison between:
a proxy voltage that corresponds to the power; and
a second threshold voltage.

10. The apparatus of claim 9 wherein:
the power control signal is a first power control signal;
the transmitter is configured to transmit a second power control signal when the proxy voltage is greater than the second threshold voltage; and
the receiver is configured to receive the second power control signal;
wherein the second power control signal is configured to prevent the power circuitry from providing the power to the plurality of LEDs.

11. The apparatus of claim 10 wherein:
the proxy voltage corresponds to a current driving the plurality of LEDs; and
the current is a subject of the current condition.

12. The apparatus of claim 3 further comprising a microcontroller configured to receive, from a user:
a CCT selection from the range of CCTs; and
the dimming selection.

13. The apparatus of claim 12 further comprising driver circuitry configured to control a current that is provided to the plurality of LEDs.

14. The apparatus of claim 13 wherein the driver circuitry includes:
first current-regulating gates configured to provide a first current, for a first fraction of time, to the plurality of LEDs, the first current configured to illuminate the first array of LEDs; and
second current-regulating gates configured to provide a second current, for a second fraction of time, the second current configured to illuminate the second array of LEDs.

15. The apparatus of claim 14 wherein the first current-regulating gates and second current-regulating gates include MOSFETs.

16. The apparatus of claim 14 wherein the first current and the second current are derived from the power.

17. The apparatus of claim 14 wherein the first fraction of time and the second fraction of time are transmitted to the driver circuitry via pulse width modulation (“PWM”) signals.

18. The apparatus of claim 17 wherein:
the PWM signals together define a period;
the period comprises a first fraction of the period and a second fraction of the period;
the first fraction of the period corresponds to the first fraction of time; and
the second fraction of the period corresponds to the second fraction of time.

19. The apparatus of claim 18 wherein the first fraction of the period and the second fraction of the period are determined based on the CCT selection received by the microcontroller.

20. The apparatus of claim 15 wherein when the input dimming level is in a low-end of a dimming range, the microcontroller, in operation, outputs to the driver circuitry:
when the CCT selection corresponds to the highest CCT, a first signal configured to prevent the power from being provided to the second array of LEDs; and
when the lowest CCT is selected, a second signal configured to prevent the power from being provided to the first array of LEDs.

21. The apparatus to claim 20 wherein the first signal and the second signal are pulse width modulation (“PWM”) signals.

22. The apparatus of claim 21 wherein the driver circuitry further includes an auxiliary current-regulating gate that in response to receiving the first signal is configured to prevent the second current-regulating gates from providing the second current to the second array of LEDs.

23. The apparatus of claim 22 wherein:
the auxiliary current-regulating gate is a first auxiliary current-regulating gate; and
the driver circuitry further includes a second auxiliary current-regulating gate that in response to receiving the second signal is configured to prevent the first current-regulating gates from providing the first current to the first array of LEDs.

24. The apparatus of claim 23 wherein:
the first auxiliary current-regulating gate includes a MOSFET; and
the second auxiliary current-regulating gate includes a MOSFET.

25. The apparatus of claim 3 wherein the dimming selection is a 0-10V dimming selection.

26. The apparatus of claim 3 wherein the dimming selection is an electronic low voltage (“ELV”) dimming selection.

27. The apparatus of claim 3 wherein the dimming selection is a triode for alternating current (“TRIAC”) dimming selection.

28. The apparatus of claim 3 wherein the control circuitry further includes a resistance that is configured to provide the shifted dimming level based on the input dimming level.

29. Apparatus for providing light having a color correlated temperature (“CCT”) selectable from a range of CCTs, the range of CCTs including a highest CCT, a lowest CCT and a plurality of CCTs between the highest CCT and the lowest CCT, the apparatus comprising:
power circuitry configured to provide power to a plurality of light-emitting diodes (LEDs) including a first array of LEDs having a first polarity and the highest CCT coupled in parallel with a second array of LEDs having a second polarity and the lowest CCT; and
control circuitry that:
is configured to:
receive an input dimming level corresponding to a dimming selection selected by a user;
provide a shifted dimming level based on the input dimming level; and
detect a voltage condition corresponding to the shifted dimming level; and
includes a switch that is configured to transmit a power control signal that is configured to modulate the power based on the voltage condition.

30. (canceled)
